(19) United States
(12) Patent Application Publication
(10) Pub. No.: US 2023/0265252 A1
(43) Pub. Date: Aug. 24, 2023

(54) NON-THERMOPLASTIC POLYIMIDE FILM, MULTI-LAYERED POLYIMIDE FILM AND METAL-CLAD LAMINATE

(71) Applicant: KANEKA CORPORATION, Osaka (JP)

(72) Inventors: Takahiro Sato, Osaka (JP); Seiji Hosogai, Osaka (JP); Mari Uno, Osaka (JP); Keisuke Oguma, Osaka (JP)

(73) Assignee: KANEKA CORPORATION, Osaka (JP)

(21) Appl. No.: 18/137,757

(22) Filed: Apr. 21, 2023

Related U.S. Application Data
(63) Continuation of application No. PCT/JP2021/038393, filed on Oct. 18, 2021.

(30) Foreign Application Priority Data
Oct. 22, 2020 (JP) 2020-177533

(51) Int. Cl. C08J 5/18; C08G 73/10

(52) U.S. Cl. CPC C08J 5/18; C08G 73/10; C08J 2379/08

(57) ABSTRACT

A non-thermoplastic polyimide film contains non-thermoplastic polyimide. The non-thermoplastic polyimide has a 3,3′,4,4′-biphenyltetracarboxylic dianhydride residue, a 4,4′-oxydiphthalic anhydride residue, a p-phenylenediamine residue and a 1,3-bis(4-aminophenoxy)benzene residue. Where the content ratio of the 3,3′,4,4′-biphenyltetracarboxylic dianhydride residue is A₁ mol %, the content ratio of the 4,4′-oxydiphthalic anhydride residue is A₂ mol %, the content ratio of the p-phenylenediamine residue is B₁ mol %, and the content ratio of the 1,3-bis(4-aminophenoxy)benzene residue is B₂ mol %, the relationships of A₁+A₂≥80, B₁+B₂≥80 and (A₁+B₁)/(A₂+B₂)≤3.50 are satisfied.

### TECHNICAL FIELD

One or more embodiments of the present invention relate to a non-thermoplastic polyimide film, a multi-layered polyimide film and a metal-clad laminate.

### BACKGROUND

In recent years, demand for flexible printed circuit boards (hereinafter, sometimes referred to as “FPCs”) has been growing with an expansion of demand for electronic products mainly including smartphones, tablet personal computers, notebook personal computers and the like. Among them, FPCs in which a multi-layered polyimide film including a non-thermoplastic polyimide layer (core layer) and a thermoplastic polyimide layer (adhesive layer) is used as a material are excellent in heat resistance and flexibility, and therefore further growth of demand for these FPCs is expected. Polyimide has heat resistance sufficient to allow adaptation to a high-temperature process, and has a relatively small linear expansion coefficient, so that internal stress is less likely to occur. Thus, polyimide is suitable as a material for FPC.

In association with high-speed signal transmission in electronic devices in recent years, there has been an increasing demand for reduction of the dielectric constant and reduction of the dielectric loss tangent of an electronic substrate material for achieving an increased frequency of an electric signal propagating through a circuit. For suppressing the transmission loss of an electric signal, it is effective to reduce the dielectric constant and the dielectric loss tangent of an electronic substrate material In recent years as early days of the IoT society, there has been a growing trend toward an increased frequency, and a substrate material has been desired in which a transmission loss can be suppressed even in a region of 10 GHz or more, for example.

The transmission loss is represented by the following expression using a proportional constant (k), a frequency (f), a dielectric loss tangent (Df) and a relative dielectric constant (Dk), and the dielectric loss tangent contributes to the transmission loss to a greater degree than the relative dielectric constant Therefore, for reducing the transmission loss, it is particularly important to reduce the dielectric loss tangent.

Transmission loss=k×f×Df×(Dk)^{1/2}

As a material used for a circuit substrate that can be adapted to an increased frequency, a polyimide film (polyimide layer) that exhibits a low dielectric loss tangent is known (see, for example, Patent Documents 1 to 4).

### PATENT DOCUMENTS

Patent Document 1: Japanese Patent Laid-Open Publication No. 2014-526399

Patent Document 2: Japanese Patent Laid-Open Publication No. 2009-246201

Patent Document 3: International Publication No. WO 2018/079710

Patent Document 4: International Publication No. WO 2016/159060

However, the techniques described in Patent Documents 1 to 4 still have room for improvement in reduction of the dielectric loss tangent.

### SUMMARY

One or more embodiments of the present invention have been made in view of the above to provide a non-thermoplastic polyimide film which has a reduced dielectric loss tangent, and a multi-layered polyimide film and a metal-clad laminate using the non-thermoplastic polyimide film.

A first non-thermoplastic polyimide film according to one or more embodiments of the present invention contains non-thermoplastic polyimide. The non-thermoplastic polyimide has a 3,3′,4,4′-biphenyltetracarboxylic dianhydride residue and a 4,4′-oxydiphthalic anhydride residue as tetracarboxylic dianhydride residues, and a p-phenylenediamine residue and a 1,3-bis(4-aminophenoxy)benzene residue as diamine residues. Where the content ratio of the 3,3′,4,4′-biphenyltetracarboxylic dianhydride residue to all tetracarboxylic dianhydride residues forming the non-thermoplastic polyimide is A₁ mol %, the content ratio of the 4,4′-oxydiphthalic anhydride residue to all tetracarboxylic dianhydride residues forming the non-thermoplastic polyimide is A₂ mol %, the content ratio of the p-phenylenediamine residue to all diamine residues forming the non-thermoplastic polyimide is B₁ mol %, and the content ratio of the 1,3-bis(4-aminophenoxy)benzene residue to all diamine residues forming the non-thermoplastic polyimide is B₂ mol %, the relationships of A₁+A₂≥80, B₁+B₂≥80 and (A₁+B₁)/(A₂+B₂)≤3.50 are satisfied.

In a non-thermoplastic polyimide film according to one or more embodiments of the present invention, A₁, A₂, B₁ and B₂ satisfy the relationship of 1.60≤(A₁+B₁)/(A₂+B₂)≤3.50.

In a non-thermoplastic polyimide film according to one or more embodiments of the present invention, the non-thermoplastic polyimide further has a pyromellitic dianhydride residue as a tetracarboxylic dianhydride residue.

In a non-thermoplastic polyimide film according to one or more embodiments of the present invention, a content ratio of the pyromellitic dianhydride residue to all tetracarboxylic dianhydride residues forming the non-thermoplastic polyimide is 3 mol % or more and 12 mol % or less.

In a non-thermoplastic polyimide film according to one or more embodiments of the present invention, a substance amount ratio obtained by dividing a total substance amount of tetracarboxylic dianhydride residues forming the non-thermoplastic polyimide by a total substance amount of diamine residues forming the non-thermoplastic polyimide is 0.95 or more and 1.05 or less.

In a non-thermoplastic polyimide film according to one or more embodiments of the present invention, the non-thermoplastic polyimide film contains a crystal portion having a lamellar structure and an amorphous portion sandwiched between the crystal portions, and the lamellar period obtained by an X-ray scattering method is 15 nm or more.

A second non-thermoplastic polyimide film according to one or more embodiments of the present invention contains non-thermoplastic polyimide, includes a crystal portion having a lamellar structure and an amorphous portion sandwiched between the crystal portions, and the lamellar period obtained by an X-ray scattering method is 15 nm or more.

A multi-layered polyimide film according to one or more embodiments of the present invention includes a non-thermoplastic polyimide film according to one or more embodiments of the present invention, and an adhesive layer that is disposed on at least one surface of the non-thermoplastic polyimide film and contains thermoplastic polyimide.

In a multi-layered polyimide film according to one or more embodiments of the present invention, the adhesive layer is disposed on each of both surfaces of the non-thermoplastic polyimide film

A first metal-clad laminate according to one or more embodiments of the present invention includes a non-thermoplastic polyimide film according to one or more embodiments of the present invention, and a metal layer disposed on at least one surface of the non-thermoplastic polyimide film.

A second metal-clad laminate according to one or more embodiments of the present invention includes a multi-layered polyimide film according to one or more embodiments of the present invention, and a metal layer disposed on a main surface of at least one of the adhesive layers of the multi-layered polyimide film.

According to one or more embodiments of the present invention, it is possible to provide a non-thermoplastic polyimide film which has a reduced dielectric loss tangent, and a multi-layered polyimide film and a metal-clad laminate using the non-thermoplastic polyimide film.

### BRIEF DESCRIPTION OF THE DRAWINGS

FIG. 1 is a sectional view showing an example of a multi-layered polyimide film according to one or more embodiments of the present invention.

FIG. 2 is a sectional view showing an example of a metal-clad laminate according to one or more embodiments of the present invention.

### DETAILED DESCRIPTION

One or more embodiments of the present invention will be described in detail below, but one or more embodiments of the present invention are not limited to these embodiments. The academic documents and patent documents mentioned herein are incorporated herein by reference in their entirety.

First, terms used herein will be described. The “structural unit” refers to a repeating unit forming a polymer. The “polyimide” is a polymer containing a structural unit represented by the following general formula (1) (hereinafter, sometimes referred to as a “structural unit (1)”).

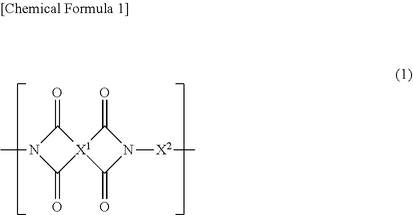

In the general formula (1), X¹ represents a tetracarboxylic dianhydride residue (tetravalent organic group derived from tetracarboxylic dianhydride), and X² represents a diamine residue (divalent organic group derived from diamine).

The content ratio of the structural unit (1) to all structural units forming the polyimide may be, for example, 50 mol % or more and 100 mol % or less, 60 mol % or more and 100 mol % or less, 70 mol % or more and 100 mol % or less, 80 mol % or more and 100 mol % or less, 90 mol % or more and 100 mol % or less, or may be 100 mol %.

The “linear expansion coefficient” is a coefficient of linear expansion during temperature elevation from 50° C. to 250° C. unless otherwise specified. The method for measuring the linear expansion coefficient is identical or similar to the method in examples described later.

The “relative dielectric constant” is a relative dielectric constant at a frequency of 10 GHz, a temperature of 23° C. and a relative humidity of 50%. The “dielectric loss tangent” is a dielectric loss tangent at a frequency of 10 GHz, a temperature of 23° C. and a relative humidity of 50%. The methods for measuring the relative dielectric constant and the dielectric loss tangent are identical or similar to the methods in examples described later.

The “non-thermoplastic polyimide” refers to polyimide that retains a film shape (flat film shape) when fixed in a metallic fixation frame in a film state and heated at a heating temperature of 380° C. for 1 minute. The “thermoplastic polyimide” refers to polyimide that does not retain a film shape when fixed in a metallic fixation frame in a film state and heated at a heating temperature of 380° C. for 1 minute.

The “main surface” of a layered material (more specifically, non-thermoplastic polyimide film, adhesive layer, multi-layered polyimide film, a metal layer or the like) refers to a surface orthogonal to the thickness direction of the layered material.

The “lamellar period” refers to a distance between centers of gravity of adjacent crystal portions (crystal portions having a lamellar structure) in a film containing a crystal portion having a lamellar structure and an amorphous portion sandwiched between the crystal portions. An amorphous portion (intermediate layer) that has not been crystallized is present between adjacent crystal portions, and in the film, a higher-order structure is formed in which a part of the amorphous portion is confined in a laminated lamellar structure. The lamellar period is determined by performing higher-order structure analysis on the film by using an X-ray scattering method (specifically, an ultra-small angle X-ray scattering method). The method for measuring the lamellar period is identical or similar to the method in examples described later.

Hereinafter, the name of a compound may be followed by the term “-based” to collectively refer to the compound and derivatives thereof. The tetracarboxylic dianhydride may be referred to as “acid dianhydride”. The non-thermoplastic polyimide contained in the non-thermoplastic polyimide film may be referred to simply as “non-thermoplastic polyimide”. The thermoplastic polyimide contained in the adhesive layer may be referred to simply as “thermoplastic polyimide”.

In the drawings that are referred to in the following description, mainly relevant components are schematically shown for easy understanding, and the size, the number, the shape and the like of each illustrated component may be different from the actual counterparts for convenience of preparing the drawings. For convenience of description, there may be cases where in the drawings that are described later, the same component parts as those in the drawings described previously are given the same symbols, and descriptions thereof are omitted.

### First Embodiment: Non-Thermoplastic Polyimide Film

The non-thermoplastic polyimide film according to a first embodiment of one or more embodiments of the present invention (hereinafter, sometimes referred to as a “non-thermoplastic polyimide film F1”) contains non-thermoplastic polyimide. The non-thermoplastic polyimide has a 3,3′,4,4′-biphenyltetracarboxylic dianhydride residue and a 4,4′-oxydiphthalic anhydride residue as tetracarboxylic dianhydride residues, and a p-phenylenediamine residue and a 1,3-bis(4-aminophenoxy)benzene residue as diamine residues. Where the content ratio of the 3,3′,4,4′-biphenyltetracarboxylic dianhydride residue to all tetracarboxylic dianhydride residues forming the non-thermoplastic polyimide is A₁ mol %, the content ratio of the 4,4′-oxydiphthalic anhydride residue to all tetracarboxylic dianhydride residues forming the non-thermoplastic polyimide is A₂ mol %, the content ratio of the p-phenylenediamine residue to all diamine residues forming the non-thermoplastic polyimide is B₁ mol %, and the content ratio of the 1,3-bis(4-aminophenoxy)benzene residue to all diamine residues forming the non-thermoplastic polyimide is B₂ mol %, the relationships of A₁+A₂≥80, B₁+B₂≥80 and (A₁+B₁)/(A₂+B₂)≤3.50 are satisfied.

Hereinafter, the 3,3′,4,4′-biphenyltetracarboxylic dianhydride may be referred to as “BPDA”. The 4,4′-oxydiphthalic anhydride may be referred to as “ODPA”. The p-phenylenediamine may be referred to as “PDA”. The 1,3-bis(4-aminophenoxy)benzene may be referred to as “TPE-R”. The pyromellitic dianhydride may be referred to as “PMDA”. The 3,3′,4,4′-benzophenone tetracarboxylic dianhydride may be referred to as “BTDA”. The p-phenylene bis(trimellitic acid monoester anhydride) may be referred to as “TMHQ”.

In the first embodiment, “A₁+A₂≥80” means that the total content ratio of the BPDA residue and the ODPA residue to all tetracarboxylic dianhydride residues forming the non-thermoplastic polyimide is 80 mol % or more. In the first embodiment, “B₁+B₂≥80” means that the total content ratio of the PDA residue and the TPE-R residue to all diamine residues forming the non-thermoplastic polyimide is 80 mol % or more.

Each of the BPDA residue and the PDA residue is a residue having a rigid structure. On the other hand, each of the ODPA residue and the TPE-R residue is a residue having a bend structure. In the first embodiment, “(A₁+B₁)/(A₂+B₂)” is an abundance ratio of residues having a rigid structure to residues having a bend structure. Hereinafter, “(A₁+B₁)/(A₂+B₂)” may be referred to as a “rigidity/bend ratio”.

The non-thermoplastic polyimide film F1 has a reduced dielectric loss tangent. The reason for this is presumed as follows.

In general, in preparation of a polyimide film, it is necessary to use a monomer having a linearly rigid structure for obtaining a stable lamellar structure. On the other hand, if an excess of a monomer having a rigid structure is used, a lamellar structure in which a molecular chain is folded by a bent portion tends to be hardly formed.

In the non-thermoplastic polyimide film F1, the total content ratio of the BPDA residue and the ODPA residue to all tetracarboxylic dianhydride residues forming the non-thermoplastic polyimide is 80 mol % or more, and the total content ratio of the PDA residue and the TPE-R residue to all the diamine residues forming the non-thermoplastic polyimide is 80 mol % or more. In the non-thermoplastic polyimide film F1, the rigidity/bend ratio is 3.50 or less. Thus, in the non-thermoplastic polyimide film F1, residues having a rigid structure and residues having a bend structure are present in a balance suitable for obtaining a stable lamellar structure, and therefore the packing property of a crystal portion having a lamellar structure tends to be enhanced.

On the other hand, in an amorphous portion confined in the laminated lamellar structure, the orientation is increased by the adjacent lamellar structure, and therefore the density is higher than that of an amorphous portion outside the laminated lamellar structure. Thus, the amorphous portion confined in the laminated lamellar structure may contribute to dielectric relaxation to a smaller degree than the amorphous portion outside the laminated lamellar structure. The “dielectric relaxation” is a phenomenon in which when an external field such as an electric field is applied to a resin, dipoles of molecules fluctuate, so that energy is released. For reducing the dielectric loss tangent, it is necessary to form a higher-order structure in which dielectric relaxation hardly occurs. The present inventors have considered that when a higher-order structure in which dielectric relaxation hardly occurs is formed by expanding the lamellar period to increase the ratio of the amorphous portion confined in the laminated lamellar structure, it is possible to reduce the dielectric loss tangent. In the non-thermoplastic polyimide film F1, the packing property of a crystal portion having a lamellar structure tends to be enhanced, and therefore the distance between adjacent crystal portions tends to increase, leading to expansion of the lamellar period. Thus, the non-thermoplastic polyimide film F1 has a reduced dielectric loss tangent.

In the first embodiment, for reducing the linear expansion coefficient, the rigidity/bend ratio may be 1.60 or more, or 1.70 or more.

Hereinafter, details of the non-thermoplastic polyimide film F1 will be described.

### Non-Thermoplastic Polyimide

The non-thermoplastic polyimide contained in the non-thermoplastic polyimide film F1 may have, in addition to the BPDA residue and the ODPA residue, other acid dianhydride residues. Examples of the acid dianhydride (monomer) for forming other acid dianhydride residues (acid dianhydride residues other than the BPDA residue and the ODPA residue) include PMDA, BTDA, TMHQ, 2,3,6,7-naphthalenetetracarboxylic dianhydride, 1,2,5,6-naphthalenetetracarboxylic dianhydride, 2,2′,3,3′-biphenyltetracarboxylic dianhydride, 2,2′,3,3′-benzophenonetetracarboxylic dianhydride, 3,4′-oxydiphthalic anhydride, 2,2-bis(3,4-dicarboxyphenyl)propane dianhydride, 3,4,9,10-perylene tetracarboxylic dianhydride, 1,1-bis(2,3-dicarboxyphenyl)ethane dianhydride, 1,1-bis(3,4-dicarboxyphenyl)ethane dianhydride, ethylenebis(trimellitic acid monoester acid anhydride), bisphenol A bis(trimellitic acid monoester acid anhydride), and derivatives thereof.

For obtaining the non-thermoplastic polyimide film F1 which has a further reduced dielectric loss tangent, the other acid dianhydride residue may be one or more selected from the group consisting of a PMDA residue, a BTDA residue and a TMHQ residue. For obtaining the non-thermoplastic polyimide film F1 which has a further reduced dielectric loss tangent while having high heat resistance, the other acid dianhydride residue may be a PMDA residue.

For obtaining the non-thermoplastic polyimide film F1 which has a further reduced dielectric loss tangent, the total content ratio of the BPDA residue and the ODPA residue to all acid dianhydride residues forming the non-thermoplastic polyimide may be 83 mol % or more, and may be 85 mol % or more, 88 mol % or more, 90 mol % or more, or 92 mol % or more, or may be 100 mol %.

When a PMDA residue is used as the other acid dianhydride residue, the total content ratio of the BPDA residue, the ODPA residue and the PMDA residue to all acid dianhydride residues forming the non-thermoplastic polyimide may be 85 mol % or more, 90 mol % or more, and may be 100 mol %, for obtaining the non-thermoplastic polyimide film F1 which has a further reduced dielectric loss tangent while having high heat resistance.

For obtaining the non-thermoplastic polyimide film F1 which has a further reduced dielectric loss tangent, the content ratio of the BPDA residue to all acid dianhydride residues forming the non-thermoplastic polyimide acid may be 20 mol % or more and 70 mol % or less, or 25 mol % or more and 65 mol % or less.

For obtaining the non-thermoplastic polyimide film F1 which has a further reduced dielectric loss tangent, the content ratio of the ODPA residue to all acid dianhydride residues forming the non-thermoplastic polyimide acid may be 20 mol % or more and 70 mol % or less, or 30 mol % or more and 60 mol % or less.

For obtaining the non-thermoplastic polyimide film F1 which has a further reduced dielectric loss tangent while having high heat resistance, the content ratio of the PMDA residue to all acid dianhydride residues forming the non-thermoplastic polyimide acid may be 1 mol % or more and 15 mol % or less, or 3 mol % or more and 12 mol % or less.

For obtaining the non-thermoplastic polyimide film F1 which has a further reduced dielectric loss tangent, the content ratio of the BTDA residue to all acid dianhydride residues forming the non-thermoplastic polyimide acid may be 1 mol % or more and 5 mol % or less, or 2 mol % or more and 4 mol % or less.

For obtaining the non-thermoplastic polyimide film F1 which has a further reduced dielectric loss tangent, the content ratio of the TMHQ residue to all acid dianhydride residues forming the non-thermoplastic polyimide acid may be 4 mol % or more and 8 mol % or less, or 5 mol % or more and 7 mol % or less.

The non-thermoplastic polyimide contained in the non-thermoplastic polyimide film F1 may have, in addition to the PDA residue and the TPE-R residue, other diamine residues. Examples of the diamine (monomer) for forming other diamine residues (diamine residues other than the PDA residue and the TPE-R residue) include 1,4-bis(4-aminophenoxy)benzene, 4,4′-diaminodiphenylpropane, 4,4′-diaminodiphenylmethane, 4,4′-diaminodiphenyl sulfide, 3,3′-diaminodiphenyl sulfone, 4,4′-diaminodiphenyl sulfone, 3,3′-diaminodiphenyl ether, 3,4′-diaminodiphenyl ether, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl N-methylamine, 4,4′-diaminodiphenyl N-phenylamine, 1,3-diaminobenzene, 1,2-diaminobenzene, and derivatives thereof.

For obtaining the non-thermoplastic polyimide film F1 which has a further reduced dielectric loss tangent, the total content ratio of the PDA residue and the TPE-R residue to all diamine residues forming the non-thermoplastic polyimide may be 85 mol % or more, 90 mol % or more, 95 mol % or more, or may be 100 mol %.

For obtaining the non-thermoplastic polyimide film F1 which has a further reduced dielectric loss tangent, the content ratio of the PDA residue to all diamine residues forming the non-thermoplastic polyimide acid may be 70 mol % or more and 98 mol % or less, or 80 mol % or more and 95 mol % or less.

For obtaining the non-thermoplastic polyimide film F1 which has a further reduced dielectric loss tangent, the content ratio of the TPE-R residue to all diamine residues forming the non-thermoplastic polyimide acid may be 2 mol % or more and 30 mol % or less, or 5 mol % or more and 20 mol % or less.

For obtaining the non-thermoplastic polyimide film F1 which has a further reduced dielectric loss tangent, a substance amount ratio obtained by dividing the total substance amount of acid dianhydride residues forming the non-thermoplastic polyimide by the total substance amount of diamine residues forming the non-thermoplastic polyimide may be 0.95 or more and 1.05 or less, 0.97 or more and 1.03 or less, or 0.99 or more and 1.01 or less.

The non-thermoplastic polyimide film F1 may contain components (additives) other than the non-thermoplastic polyimide. As the additive, for example, a dye, a surfactant, a leveling agent, a plasticizer, silicone, a filler, a sensitizer and the like can be used. The content ratio of the non-thermoplastic polyimide in the non-thermoplastic polyimide film F1 may be, for example, 70 wt % or more, 80 wt % or more, 90 wt % or more, or may be 100 wt %, based on the total amount of the non-thermoplastic polyimide film F1.

For obtaining the non-thermoplastic polyimide film F1 which has a further reduced dielectric loss tangent and a small linear expansion coefficient, it is preferable to satisfy the following condition 1, it is more preferable to satisfy the following condition 2, it is still more preferable to satisfy the following condition 3, and it is particularly preferable to satisfy the following condition 4.

Condition 1: The non-thermoplastic polyimide has only a PDA residue and a TPE-R residue as diamine residues, and has a rigidity/bend ratio of 1.60 or more and 3.50 or less.

Condition 2: The condition 1 is satisfied, and the non-thermoplastic polyimide further has a PMDA residue as an acid dianhydride residue.

Condition 3: The condition 2 is satisfied, and the total content ratio of the BPDA residue, the ODPA residue and the PMDA residue to all acid dianhydride residues forming the non-thermoplastic polyimide is 90 mol % or more and 100 mol % or less.

Condition 4: The condition 3 is satisfied, and the content ratio of the PMDA residue to all acid dianhydride residues forming the non-thermoplastic polyimide is 3 mol % or more and 12 mol % or less.

### Method for Producing Non-Thermoplastic Polyimide Film F1

The non-thermoplastic polyimide contained in the non-thermoplastic polyimide film F1 is obtained by imidizing polyamide acid as a precursor of the non-thermoplastic polyimide.

As the method for producing (synthesizing) the polyamide acid, any of known methods and combinations thereof can be used. In production of polyamide acid, normally, diamine and tetracarboxylic dianhydride are reacted in an organic solvent. It is preferable that the substance amount of diamine and the substance amount of tetracarboxylic dianhydride in the reaction are substantially the same. When polyamide acid is synthesized using diamine and tetracarboxylic dianhydride, desired polyamide acid (polymer of diamine and tetracarboxylic dianhydride) can be obtained by adjusting the substance amount of each diamine and the substance amount of each tetracarboxylic dianhydride. The molar fraction of each residue in polyimide formed from the polyamide acid is equal to, for example, the molar fraction of each monomer (each of diamine and tetracarboxylic dianhydride) used for synthesis of the polyamide acid. The temperature condition for the reaction of diamine with tetracarboxylic dianhydride, i.e. the reaction for synthesis of the polyamide acid is not particularly limited, and is, for example, in the range of 10° C. or higher and 150° C. or lower. The time for the synthesis reaction of the polyamide acid is in the range of, for example, 10 minutes or more and 30 hours or less. In the present embodiment, any method for adding a monomer may be used for production of polyamide acid. Examples of the typical method for producing polyamide acid include the following methods.

Examples of the method for producing polyamide acid include a method in which polymerization is performed by the following steps (A-a) and (A-b) (hereinafter, sometimes referred to as “polymerization method A”).

(A-a): reacting diamine with acid dianhydride in an organic solvent with the diamine being in excess to obtain a prepolymer having an amino group at each of both ends.

(A-b): adding diamine different in structure from that used in step (A-a), and further adding acid dianhydride different in structure from that used in the step (A-a) so that the amounts of diamine and the acid dianhydride in the entire step are substantially equal to each other in terms of mol, thereby performing polymerization.

Examples of the method for producing polyamide acid also include a method in which polymerization is performed by the following steps (B-a) and (B-b) (hereinafter, sometimes referred to as “polymerization method B”).

(B-a): reacting diamine with acid dianhydride in an organic solvent with the acid dianhydride being in excess to obtain a prepolymer having an acid anhydride group at both ends.

(B-b): adding acid dianhydride different in structure from that used in step (B-a), and further adding diamine different in structure from that used in the step (B-a) so that the amounts of diamine and the acid dianhydride in the entire step are substantially equal to each other in terms of mol, thereby performing polymerization.

A polymerization method in which the order of addition is set so that specific diamine or specific acid dianhydride selectively reacts with any or specific diamine or any or specific acid dianhydride (e.g. the above-described polymerization method A or polymerization method B) is herein referred to as sequence polymerization. On the other hand, a polymerization method in which the order of addition of diamine and acid dianhydride is not set (polymerization method in which monomers freely react with each other) is herein referred to as random polymerization. When sequence polymerization is performed in two steps as in polymerization method A and polymerization method B, the earlier step (step (A-a), step (B-a) or the like) is herein referred to as a “first sequence polymerization step”, and the latter step (step (A-b), step (B-b) or the like) is herein referred to as a “second sequence polymerization step”.

In the present embodiment, for obtaining the non-thermoplastic polyimide film F1 which has a further reduced dielectric loss tangent, the method for polymerization of polyamide acid may be sequence polymerization.

For obtaining non-thermoplastic polyimide, a method may be adopted in which the non-thermoplastic polyimide is obtained from a polyamide acid solution containing polyamide acid and an organic solvent. Examples of the organic solvent usable for the polyamide acid solution include urea-based solvents such as tetramethylurea and N,N-dimethylethylurea; sulfoxide-based solvents such as dimethyl sulfoxide; sulfone-based solvents such as diphenyl sulfone and tetramethyl sulfone; amide-based solvents such as N,N-dimethylacetamide, N,N-dimethylformamide (hereinafter, sometimes referred to as “DMF”), N,N-diethylacetamide, N-methyl-2-pyrrolidone and hexamethylphosphoric triamide; ester-based solvents such as γ-butyrolactone; alkyl halide-based solvents such as chloroform and methylene chloride; aromatic hydrocarbon-based solvents such as benzene and toluene; phenol-based solvents such as phenol and cresol; ketone-based solvents such as cyclopentanone; and ether-based solvents such as tetrahydrofuran, 1,3-dioxolane, 1,4-dioxane, dimethyl ether, diethyl ether, diethylene glycol diethyl ether, diethylene glycol dimethyl ether and p-cresol methyl ether. Normally, one of these solvents is used alone, but if necessary, two or more thereof may be used in combination as appropriate. When the polyamide acid is obtained by the polymerization method described above, the reaction solution (solution after reaction) itself may be a polyamide acid solution for obtaining non-thermoplastic polyimide. In this case, the organic solvent in the polyamide acid solution is the organic solvent used in the reaction in the polymerization method. The solid polyamide acid obtained by removing the solvent from the reaction solution may be dissolved in an organic solvent to prepare a polyamide acid solution.

Additives such as a dye, a surfactant, a leveling agent, a plasticizer, silicone, a filler and a sensitizer may be added to the polyamide acid solution. The concentration of the polyamide acid in the polyamide acid solution is not particularly limited, and may be, for example, 5 wt % or more and 35 wt % or less, or 8 wt % or more and 30 wt % or less, based on the total amount of the polyamide acid solution. When the concentration of the polyamide acid is 5 wt % or more and 35 wt % or less, an appropriate molecular weight and solution viscosity are obtained.

The method for obtaining the non-thermoplastic polyimide film F1 using the polyamide acid solution is not particularly limited, and various known methods can be applied. Examples thereof include a method in which the non-thermoplastic polyimide film F1 is obtained by passing through the following steps i) to iii).

Step i): applying a dope solution containing a polyamide acid solution onto a support to form a coating film.

Step ii): drying the coating film on the support to obtain a polyamide acid film (hereinafter, sometimes referred to as a “gel film”) having a self-supporting property, followed by peeling off the gel film from the support.

Step iii): heating the gel film to imidize the polyamide acid in the gel film, thereby obtaining the non-thermoplastic polyimide film F1 containing non-thermoplastic polyimide.

The method for obtaining the non-thermoplastic polyimide film F1 by passing through steps i) to iii) is classified broadly into a thermal imidization method and a chemical imidization method. The thermal imidization method is a method in which a dehydrating and ring-closing agent or the like is not used, and a polyamide acid solution is applied onto a support as a dope solution, and heated to promote imidization. On the other hand, the chemical imidization method is a method in which a polyamide acid solution, to which at least one of a dehydrating and ring-closing agent and a catalyst is added, is used as a dope solution to accelerate imidization. Either of the methods may be used, and the chemical imidization method is superior in productivity.

As the dehydrating and ring-closing agent, acid anhydride typified by acetic anhydride is suitably used. As the catalyst, tertiary amine such as aliphatic tertiary amine, aromatic tertiary amine or heterocyclic tertiary amine (more specifically, isoquinoline or the like) is suitably used. When at least one of the dehydrating and ring-closing agent and the catalyst is added to the polyamide acid solution, they may be added directly without being dissolved in an organic solvent, or may be dissolved in an organic solvent, followed by addition of the resulting solution. In the method of direct addition without dissolution in an organic solvent, the reaction may rapidly proceed before diffusion of at least one of the dehydrating and ring-closing agent and the catalyst, resulting in generation of gel. Thus, it is preferable that a solution obtained by dissolving the at least one of the dehydrating and ring-closing agent and the catalyst in an organic solvent is added to the polyamide acid solution.

The method for applying the dope solution onto the support in step i) is not particularly limited, and a method using a heretofore known applicator such as a die coater, Comma Coater (registered trademark), a reverse coater or a knife coater can be adopted.

As the support to which the dope solution is applied in step i), a glass plate, an aluminum foil, an endless stainless belt, a stainless drum or the like is suitably used. In step ii), conditions for drying (heating) the coating film are set according to the thickness of the ultimately obtained film, and the production speed, and the dried polyamide acid film (gel film) is peeled from the support. The temperature for drying the coating film is, for example, 50° C. or higher and 200° C. or lower. The drying time during drying of the coating film is, for example, 1 minute or more and 100 minutes or less.

Subsequently, in step iii), water, the remaining solvent, an imidization accelerator and the like are removed from the gel film by, for example, performing heating treatment while avoiding shrinkage during curing with the gel film fixed at its end portion, and the polyamide acid that is left is completely imidized to obtain the non-thermoplastic polyimide film F1 containing non-thermoplastic polyimide. The heating conditions are appropriately set according to the thickness of the ultimately obtained film, and the production speed. As the heating conditions in step iii), the maximum temperature is, for example, 370° C. or higher and 420° C. or lower, and the heating time at the maximum temperature is, for example, 10 seconds or more and 180 seconds or less. The laminate may be held at any temperature for any period of time until attainment of the maximum temperature. Step may be carried out in air, under reduced pressure or in an inert gas such as nitrogen. The heater that can be used in step iii) is not particularly limited, and examples thereof include hot air circulation ovens and far infrared ray ovens.

The non-thermoplastic polyimide film F1 thus obtained has a reduced dielectric loss tangent, and is therefore suitable for, for example, a material of a high-frequency circuit board (more specifically, a core layer of a multi-layered polyimide film, an insulating layer of a metal-clad laminate or the like).

### Physical Properties of Non-Thermoplastic Polyimide Film F1

For obtaining the non-thermoplastic polyimide film F1 which has a further reduced dielectric loss tangent, the lamellar period of the non-thermoplastic polyimide film F1 may be 15 nm or more, 20 nm or more, 23 nm or more, and may be 24 nm or more, 25 nm or more, 26 nm or more, 27 nm or more, 28 nm or more, 29 nm or more, 30 nm or more, 31 nm or more, 32 nm or more, 33 nm or more, 34 nm or more, 35 nm or more, 36 nm or more, 37 nm or more, 38 nm or more, 39 nm or more, or 40 nm or more. The upper limit of the lamellar period of the non-thermoplastic polyimide film F1 is not particularly limited, and is, for example, 60 nm.

The lamellar period of the non-thermoplastic polyimide film F1 can be adjusted by, for example, changing at least one of the content ratio of each residue forming the non-thermoplastic polyimide and the heating conditions (more specifically, maximum temperature, heating time at maximum temperature, and the like) in step iii) above.

For reducing the transmission loss, the relative dielectric constant of the non-thermoplastic polyimide film F1 may be 3.60 or less. For reducing the transmission loss, the dielectric loss tangent of the non-thermoplastic polyimide film F1 may be 0.0050 or less, 0.0040 or less, or less than 0 0030.

For suppressing occurrence of internal stress in use for FPC, the linear expansion coefficient of the non-thermoplastic polyimide film F1 may be 25 ppm/K or less, 18 ppm/K or less, or 16 ppm/K or less.

The thickness of the non-thermoplastic polyimide film F1 is not particularly limited, and is, for example, 5 μm or more and 50 μm or less. The thickness of the non-thermoplastic polyimide film F1 can be measured by using Laser Hologage.

### Second Embodiment: Non-Thermoplastic Polyimide Film

Next, a non-thermoplastic polyimide film according to a second embodiment of one or more embodiments of the present invention (hereinafter, sometimes referred to as a “non-thermoplastic polyimide film F2”) will be described. In the following description, descriptions of contents overlapping with those of the first embodiment may be omitted. Hereinafter, matters different from those of the first embodiment (non-thermoplastic polyimide film F1) will be mainly described.

The non-thermoplastic polyimide film F2 contains non-thermoplastic polyimide, includes a crystal portion having a lamellar structure and an amorphous portion sandwiched between the crystal portions, and the lamellar period obtained by an X-ray scattering method is 15 nm or more. The above-described configuration of the non-thermoplastic polyimide film F2 enables reduction of the dielectric loss tangent

The non-thermoplastic polyimide film F2 is not particularly limited as long as it satisfies the above-described configuration. However, in the second embodiment, for easily adjusting the lamellar period to 15 nm or more, it is preferable to satisfy the following condition A, and it is more preferable to satisfy the following conditions A and B.

Condition A: The non-thermoplastic polyimide acid has a BPDA residue and an ODPA residue as tetracarboxylic dianhydride residues, and a PDA residue and a TPE-R residue as diamine residues.

Condition B: Where the content ratio of the BPDA residue to all tetracarboxylic dianhydride residues forming the non-thermoplastic polyimide is A₁ mol %, the content ratio of the ODPA residue to all tetracarboxylic dianhydride residues forming the non-thermoplastic polyimide is A₂ mol %, the content ratio of the PDA residue to all diamine residues forming the non-thermoplastic polyimide is B₁ mol %, and the content ratio of the TPE-R residue to all diamine residues forming the non-thermoplastic polyimide is B₂ mol %, the relationships of A₁+A₂≥80, B₁+B₂≥80 and (A₁+B₁)/(A₂+B₂)≤3.50 are satisfied.

For the rest, the second embodiment is the same as described in the above section <First embodiment: non-thermoplastic polyimide film> (including the section [Non-thermoplastic polyimide], the section [Method for producing non-thermoplastic polyimide film F1] and the section [Physical properties of non-thermoplastic polyimide film F1]).

### Third Embodiment: Multi-Layered Polyimide Film

Next, a multi-layered polyimide film according to a third embodiment of one or more embodiments of the present invention will be described. The multi-layered polyimide film according to the third embodiment includes the non-thermoplastic polyimide film F1 or the non-thermoplastic polyimide film F2, and an adhesive layer containing thermoplastic polyimide. Hereinafter, the “non-thermoplastic polyimide film F1 or non-thermoplastic polyimide film F2” may be referred to as a “specific non-thermoplastic polyimide film”. In the following description, descriptions of contents overlapping with those of the first embodiment and the second embodiment may be omitted.

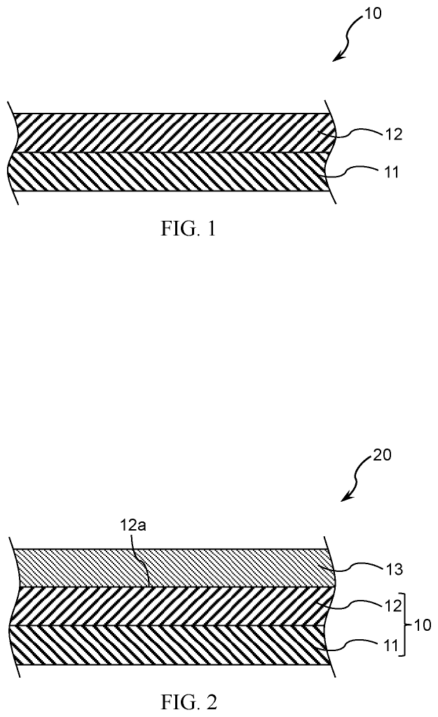

FIG. 1 is a sectional view showing the multi-layered polyimide film according to the third embodiment. As shown in FIG. 1, a multi-layered polyimide film 10 includes a specific non-thermoplastic polyimide film 11, and an adhesive layer 12 that is disposed on at least one surface (one main surface) of the specific non-thermoplastic polyimide film 11 and contains thermoplastic polyimide.

In the multi-layered polyimide film 10 shown in FIG. 1, the adhesive layer 12 is provided only on one surface of the specific non-thermoplastic polyimide film 11, but the adhesive layer 12 may be provided on each of both surfaces (both main surfaces) of the specific non-thermoplastic polyimide film 11. When the adhesive layer 12 is provided on each of both surfaces of the specific non-thermoplastic polyimide film 11, the two adhesive layers 12 may contain the same kind of polyimide or mutually different kinds of polyimide. The thicknesses of the two adhesive layers 12 may be the same or different. In the following description, the “multi-layered polyimide film 10” includes a film having the adhesive layer 12 provided only on one surface of the specific non-thermoplastic polyimide film 11, and a film having the adhesive layer 12 provided on each of both surfaces of the specific non-thermoplastic polyimide film 11.

The thickness of the multi-layered polyimide film 10 (total thickness of the layers) is, for example, 6 μm or more and 60 μm or less. It becomes easier to reduce the weight of FPC obtained and the bendability of FPC obtained is improved as the thickness of the multi-layered polyimide film 10 decreases. For easily reducing the weight of FPC while securing mechanical strength, and improving the bendability of FPC, the thickness of the multi-layered polyimide film 10 may be 7 μm or more and 60 μm or less, or 10 μm or more and 60 μm or less. The thickness of the multi-layered polyimide film 10 can be measured by using Laser Hologage.

For easily reducing the thickness of FPC while securing adhesion to the metal foil, the thickness of the adhesive layer 12 (thickness of each adhesive layer 12 when two adhesive layers 12 are provided) may be 1 μm or more and 15 μm or less. For easily adjusting the linear expansion coefficient of the multi-layered polyimide film 10, the thickness ratio between the specific non-thermoplastic polyimide film 11 and the adhesive layer 12 (thickness of specific non-thermoplastic polyimide film 11/thickness of adhesive layer 12) may be 55/45 or more and 95/5 or less. When two adhesive layers 12 are provided, the thickness of the adhesive layer 12 is the total thickness of adhesive layers 12.

For suppressing warpage of the multi-layered polyimide film 10, it is preferable that the adhesive layer 12 is provided on each of both surfaces of the specific non-thermoplastic polyimide film 11, and it is more preferable that the adhesive layers 12 containing the same kind of polyimide are provided on both surfaces of the specific non-thermoplastic polyimide film 11. When the adhesive layer 12 is provided on each of both surfaces of the specific non-thermoplastic polyimide film 11, the thicknesses of the two adhesive layers 12 may be the same for suppressing warpage of the multi-layered polyimide film 10. Even if the thicknesses of the two adhesive layers 12 are different from each other, warpage of the multi-layered polyimide film 10 can be suppressed when the thickness of the thinner adhesive layer 12 is in the range of 40% or more and less than 100% based on the thickness of the thicker adhesive layer 12.

### Adhesive Layer 12

The thermoplastic polyimide contained in the adhesive layer 12 has an acid dianhydride residue and a diamine residue. Examples of the acid dianhydride (monomer) for forming the acid dianhydride residue in the thermoplastic polyimide include the same compound as the acid dianhydride (monomer) for forming the acid dianhydride residue in the non-thermoplastic polyimide. The type of the acid dianhydride residue of the thermoplastic polyimide and the type of the acid dianhydride residue of the non-thermoplastic polyimide may be the same or different.

For securing thermoplasticity, the diamine residue of the thermoplastic polyimide may be a diamine residue having a bend structure. For more easily securing thermoplasticity, the content ratio of the diamine residue having a bend structure may be 50 mol % or more, 70 mol % or more, 80 mol % or more, or may be 100 mol %, based on the amount of all diamine residues forming the thermoplastic polyimide. Examples of the diamine (monomer) for forming a diamine residue having a bend structure include 4,4′-bis(4-aminophenoxy)biphenyl, 4,4′-bis(3-aminophenoxy)biphenyl, 1,3-bis(3-aminophenoxy)benzene, TPE-R, and 2,2-bis[4-(4-aminophenoxy)phenyl]propane (hereinafter, sometimes referred to as “BAPP”). For more easily securing thermoplasticity, the diamine residue of the thermoplastic polyimide is a BAPP residue.

For obtaining the adhesive layer 12 excellent in adhesion to the metal foil, it is preferable that the thermoplastic polyimide has one or more selected from the group consisting of a BPDA residue and a PMDA residue, and a BAPP residue.

The adhesive layer 12 may contain components (additives) other than the thermoplastic polyimide. As the additive, for example, a dye, a surfactant, a leveling agent, a plasticizer, silicone, a filler, a sensitizer and the like can be used. The content ratio of the thermoplastic polyimide in the adhesive layer 12 may be, for example, 70 wt % or more, 80 wt % or more, 90 wt % or more, or may be 100 wt %, based on the total amount of the adhesive layer 12.

### Method for Forming Adhesive Layer 12

The adhesive layer 12 is formed by, for example, applying a polyamide acid solution containing a polyamide acid as a precursor of thermoplastic polyimide (hereinafter, sometimes referred to as a “thermoplastic polyamide acid solution”) to at least one surface of the specific non-thermoplastic polyimide film 11, and then performing heating (drying and imidization of the polyamide acid). By this method, the multi-layered polyimide film 10 is obtained which includes the specific non-thermoplastic polyimide film 11 and the adhesive layer 12 disposed on at least one surface of the specific non-thermoplastic polyimide film 11. Instead of the thermoplastic polyamide acid solution, a solution containing a thermoplastic polyimide (thermoplastic polyimide solution) may be used to form a coating film of a thermoplastic polyimide solution on at least one surface of the specific non-thermoplastic polyimide film 11, followed by drying the coating film to form the adhesive layer 12.

For example, a laminate including a layer containing polyamide acid as a precursor of the non-thermoplastic polyimide of the specific non-thermoplastic polyimide film 11 and a layer containing polyamide acid as a precursor of the thermoplastic polyimide may be formed on a support by using a coextrusion die, followed by heating the obtained laminate to form the specific non-thermoplastic polyimide film 11 and the adhesive layer 12 at the same time. In this method, by using a metal foil as the support, a metal-clad laminate (laminate of multi-layered polyimide film 10 and metal foil) is obtained when the imidization is completed.

When the multi-layered polyimide film 10 including three polyimide layers is produced, a method is suitably used in which the above-described application step and the heating step are repeated more than once, or a plurality of coating films are formed by co-extrusion or continuous application (continuous casting), and heated at a time. It is also possible to perform various surface treatments such as corona treatment and plasma treatment on the outermost surface of the multi-layered polyimide film 10.

### Fourth Embodiment: Metal-Clad Laminate

Next, a metal-clad laminate according to a fourth embodiment of one or more embodiments of the present invention (hereinafter, sometimes referred to as a “metal-clad laminate M1”) will be described. The metal-clad laminate M1 includes a specific non-thermoplastic polyimide film and a metal layer disposed on at least one surface (one main surface) of the specific non-thermoplastic polyimide film. In the following description, descriptions of contents overlapping with those of the first embodiment and the second embodiment may be omitted.

The metal-clad laminate M1 is obtained by, for example, forming a first plating layer on one surface or both surfaces of a specific non-thermoplastic polyimide film by a dry plating method, and then forming a second plating layer on the first plating layer by a wet plating method (electroless plating method, electrolytic plating method or the like). Examples of the dry plating method include PVD methods (more specifically, vacuum vapor deposition method, sputtering method, ion plating method and the like) and CVD methods. The thickness (total thickness) of the metal layer including the first plating layer and the second plating layer is, for example, 1 μm or more and 50 μm or less.

Examples of the method for obtaining the metal-clad laminate M1 include, in addition to the above-described methods, a method in which a solution containing polyamide acid as a precursor of a non-thermoplastic polyimide (specifically, non-thermoplastic polyimide of specific non-thermoplastic polyimide film) is applied onto a metal foil, and then the coating film formed on the metal foil is heated (hereinafter, sometimes referred to as an “application method”). By heating the coating film, the solvent is removed and imidized on the metal foil to obtain a metal-clad laminate M1 which is a laminate of a specific non-thermoplastic polyimide film and a metal layer including a metal foil.

The applicator for applying a solution containing polyamide acid onto the metal foil in the application method is not particularly limited, and examples thereof include die coaters, Comma Coater (registered trademark), reverse coaters and knife coaters. The heater for heating the coating film is not particularly limited, and for example, a hot air circulation oven, a far infrared ray oven or the like can be used.

The metal foil that can be used in the application method is not particularly limited. As the metal foil that can be used in the application method, for example, a metal foil made of any of materials such as copper, stainless steel, nickel, aluminum and alloys of these metals is suitably used. In general metal-clad laminates, a copper foil such as a rolled copper foil or an electrolytic copper foil is often used, and in the fourth embodiment, a copper foil may be used. As the metal foil, one subjected to surface treatment or the like to adjust surface roughness or the like according to a purpose can be used. Further, a rustproof layer, a heat resistant layer, an adhesive layer, and the like may be formed on the surface of the metal foil. The thickness of the metal foil is not particularly limited, and may a thickness that allows a sufficient function to be exhibited according to a use purpose. For easily reducing the thickness of FPC while securing handleability, the thickness of the metal foil may be 5 μm or more and 50 μm or less.

### Fifth Embodiment: Metal-Clad Laminate

Next, a metal-clad laminate according to a fifth embodiment of one or more embodiments of the present invention (hereinafter, sometimes referred to as a “metal-clad laminate M2”) will be described. The metal-clad laminate M2 includes a multi-layered polyimide film according to the third embodiment and a metal layer disposed on a main surface of at least one of the adhesive layers of the multi-layered polyimide film. In the following description, descriptions of contents overlapping with those of the first embodiment, the second embodiment and the third embodiment may be omitted.

FIG. 2 is a sectional view showing an example of the metal-clad laminate M2. As shown in FIG. 2, a metal-clad laminate 20 has a multi-layered polyimide film 10 and a metal layer 13 (metal foil) disposed on a main surface 12a of an adhesive layer 12 of the multi-layered polyimide film 10.

Method for Producing Metal-Clad Laminate 20

In production of the metal-clad laminate 20 by use of the multi-layered polyimide film 10, a metal foil as the metal layer 13 is bonded to at least one surface of the multi-layered polyimide film 10 (for example, in FIG. 2, main surface 12a of adhesive layer 12 on a side opposite to specific non-thermoplastic polyimide film 11 side). In this way, the metal-clad laminate 20 shown in FIG. 2 is obtained. The method for bonding a metal foil to the main surface 12a of the adhesive layer 12 is not particularly limited, and various known methods can be adopted. It is possible to adopt, for example, a continuous processing method using a hot-roll lamination apparatus having one or more pairs of metal rolls, or a double belt press (DBP). The specific configuration of the means for carrying out the hot-roll lamination is not particularly limited, and it is preferable to dispose a protective material between the pressed surface and the metal foil for improving the appearance of the metal-clad laminate 20 obtained.

When the adhesive layer 12 is provided on each of both surfaces of the specific non-thermoplastic polyimide film 11, a double-sided metal-clad laminate (not shown) is obtained by bonding a metal foil to each of both surfaces (both main surfaces) of the multi-layered polyimide film 10.

The metal foil as the metal layer 13 is not particularly limited, and any metal foil can be used. For example, a metal foil made of any of materials such as copper, stainless steel, nickel, aluminum and alloys of these metals is suitably used. In general metal-clad laminates, a copper foil such as a rolled copper foil or an electrolytic copper foil is often used, and in the fifth embodiment, a copper foil may be used. As the metal foil, one subjected to surface treatment or the like to adjust surface roughness or the like according to a purpose can be used. Further, a rustproof layer, a heat resistant layer, an adhesive layer, and the like may be formed on the surface of the metal foil. The thickness of the metal foil is not particularly limited, and may a thickness that allows a sufficient function to be exhibited according to a use purpose. For easily reducing the thickness of FPC while suppressing generation of creases in bonding to the multi-layered polyimide film 10, the thickness of the metal foil may be 5 μm or more and 50 μm or less.

### EXAMPLES

Hereinafter, one or more embodiments of the present invention will be described in more detail by way of examples, but one or more embodiments of the present invention are not limited to these examples.

### Method for Measuring Physical Properties

First, methods for measuring the lamellar period, the relative dielectric constant, the dielectric loss tangent and the linear expansion coefficient of a polyimide film will be described.

### Lamellar Period

First, ten measurement samples obtained by cutting the polyimide film to 1.5 cm in length and 1.0 cm in width were provided. Subsequently, ten polyimide films were stacked in the same direction, and set in a sample holder. Subsequently, the sample holder was fitted to a sample stage of an X-ray scattering measurement apparatus (“NANOPIX (registered trademark)” manufactured by Rigaku Corporation), and optical adjustment was then performed so that an X-ray passed through the center of a cross-wire of the sample holder. Subsequently, measurement was performed under the following conditions by an ultra-small angle X-ray scattering method (USAXS) to obtain a two-dimensional SAXS image.

### Measurement Conditions

X-ray source: Cu (λ=1.5418 Å)

Detector: “HyPix (registered trademark)-6000” manufactured by Rigaku Corporation

X-ray beam diameter: 0.4 nm

Standard sample: silver behenate

Camera length: 1349.20 mm

Temperature: room temperature (20° C.)

Irradiation time: 60 minutes

Measurement range (2θ): 0 to 3.5° (=0 to 2.5 nm⁻¹)

Subsequently, the lamellar period was calculated by the following method using software “SmartLab Studio II (Powder XRD)” and “2DP” manufactured by Rigaku Corporation. First, the two-dimensional SAXS image obtained in the above-described procedure and a blank thereof were subjected to circular averaging with software “2DP” manufactured by Rigaku Corporation to obtain a one-dimensional SAXS pattern and a blank SAXS pattern, respectively. Subsequently, the blank SAXS pattern was taken as background data, and the background of the one-dimensional SAXS pattern was removed. In the removal of the background, an X-ray scattering intensity ratio was calculated from the direct beam intensities of both the patterns to correct the intensity. Subsequently, for the one-dimensional SAXS pattern after the removal of the background, a peak appearing at 2θ<1° was separated by using software “SmartLab Studio II (Powder XRD)” manufactured by Rigaku Corporation. In the separation, waveform optimization processing was performed by peak profile fitting of the initial structure.

The separation peak of 2θ<1° was identified as a lamellar period-derived peak, and a lamellar period d was calculated from a scattering vector q of the lamellar period-derived peak. The scattering vector q is calculated from the expression “q=(4πsinθ)λ (where θ is a scattering angle and λ is a wavelength of an X-ray used for measurement)”, and the lamellar period d is calculated by the expression “d=2π/q”.

### Relative Dielectric Constant and Dielectric Loss Tangent

The relative dielectric constant and the dielectric loss tangent of the polyimide film were measured by a network analyzer (“8719 C” manufactured by Hewlett-Packard Company) and a cavity resonator perturbation dielectric constant measurement apparatus (“CP531” manufactured by EM labs, Inc.). Specifically, first, the polyimide film was cut to 2 mm×100 mm to prepare a sample for measurement of the relative dielectric constant and the dielectric loss tangent. Subsequently, the measurement sample was left standing in an atmosphere at a temperature of 23° C. and a relative humidity of 50% for 24 hours, and the relative dielectric constant and the dielectric loss tangent were then measured under the conditions of a temperature of 23° C., a relative humidity of 50% and a measurement frequency of 10 GHz by using the network analyzer and the cavity resonator perturbation dielectric constant measurement apparatus. When the dielectric loss tangent was 0.0030 or less, it was evaluated that “the dielectric loss tangent was reduced”. When the dielectric loss tangent was 0.0030 or more, it was evaluated that “the dielectric loss tangent was not reduced”.

### Linear Expansion Coefficient (CTE)

By using a thermal analyzer (“TMA/SS6100” manufactured by Hitachi High-Tech Science Corporation), a polyimide film (sample) was heated from −10° C. to 300° C. at a temperature elevation rate of 10° C./min, and then cooled to −10° C. at a temperature lowering rate of 40° C./min. Subsequently, the sample was heated again to 300° C. under the condition of a temperature elevation rate of 10° C./min, and the linear expansion coefficient was determined from a strain amount at 50° C. to 250° C. during the second temperature elevation. The measurement conditions are shown below.

Size of sample (polyimide film): 3 mm in width and 10 mm in length

Load: 1 g

Measurement atmosphere: air atmosphere

### Preparation of Polyimide Film

Hereinafter, methods for producing a polyimide film in each of examples and comparative examples will be described. In the following, compounds and reagents are represented by the following abbreviations. Polyamide acid solutions for use in preparation of the polyimide films were each prepared in a nitrogen atmosphere at a temperature of 20° C.
DMF: N,N-dimethylformamide
PDA: p-phenylenediamine
TPE-R: 1,3-bis(4-aminophenoxy)benzene
ODA: 4,4′-oxydianiline
BAPP: 2,2-bis[4-(4-aminophenoxy)phenyl]propane
TPE-Q: 1,4-bis(4-aminophenoxy)benzene
m-TB: 4,4′-diamino-2,2′-dimethylbiphenyl
BPDA: 3,3′,4,4′-biphenyltetracarboxylic dianhydride
PMDA: pyromellitic dianhydride
TMHQ: p-phenylene bis(trimellitic acid monoester acid anhydride)
BTDA: 3,3′,4,4′-benzophenone tetracarboxylic dianhydride
ODPA: 4,4′-oxydiphthalic anhydride
BISDA: 5,5′-[1-methyl-1,1-ethanediylbis(1,4-phenylene)bisoxy]bis(isobenzofuran-1,3-dione)
AA: acetic anhydride
IQ: isoquinoline

### Example 1

164.2 g of DMF, 3.0 g of TPE-R and 6.4 g of PDA were put in a glass flask having a volume of 500 mL, and 12.2 g of BPDA and 7.9 g of ODPA were put in the flask while the flask contents were stirred. Subsequently, the contents of the flask were stirred for 30 minutes. Subsequently, while the flask contents were stirred, a PMDA solution prepared in advance (solvent: DMF, dissolved amount of PMDA: 0.5 g, concentration of PMDA: 7.9 wt %) was continuously added to the flask for a predetermined time at an addition rate which did not cause the viscosity of the flask contents to rapidly increase. At the time when the viscosity of the flask contents at a temperature of 23° C. reached 1500 poise, the addition of the PMDA solution was stopped, and the flask contents were stirred for 1 hour to obtain a polyamide acid solution P1. The obtained polyamide acid solution P1 had a solid content concentration of 15 wt %. The obtained polyamide acid solution P1 had a viscosity of 1500 to 2000 poise at a temperature of 23° C.

Subsequently, 27.5 g of an imidization accelerator including a mixture of AA, IQ and DMF (weight ratio: AA/IQ/DMF=42/21/37) was added to 55 g of the polyamide acid solution P1 (polyamide acid solution P1 obtained by the above-described preparation method) to prepare a dope solution. Subsequently, the dope solution was defoamed while being stirred in an atmosphere at a temperature of 0° C. or lower, and the dope solution was applied onto an aluminum foil with Comma Coater to form a coating film. Subsequently, the coating film was heated at a heating temperature of 110° C. for 180 seconds to obtain a self-supporting gel film. The obtained gel film was peeled off from the aluminum foil, fixed to a metallic fixation frame, put in a hot air circulation oven preheated to a temperature of 300° C., and heated at a heating temperature of 300° C. for 56 seconds. Subsequently, the heated film was put in a far infrared (IR) oven preheated to a temperature of 380° C., and heated at a heating temperature of 380° C. for 49 seconds to imidize the polyamide acid in the gel film, and the film was then separated from the metallic fixation frame to obtain a polyimide film (thickness: 17 μm) of Example 1.

A polyimide film obtained in the same procedure as described above was fixed to a metallic fixation frame, and heated at a heating temperature of 380° C. for 1 minute using an IR oven, and the shape of the polyimide film (film shape) was still retained. Thus, the polyimide contained in the polyimide film of Example 1 was non-thermoplastic polyimide. That is, the polyimide film of Example 1 was a non-thermoplastic polyimide film. For the polyimide films of Examples 2 to 37 and Comparative Examples 1 to 8 described below, polyimide films obtained in the same procedure as described above were each fixed to a metallic fixation frame, and heated at a heating temperature of 380° C. for 1 minute using the IR oven, and the shape of the polyimide film (film shape) was still retained. Thus, the polyimide contained in the polyimide film of each of Examples 2 to 37 and Comparative Examples 1 to 8 was non-thermoplastic polyimide. That is, the polyimide film of each of Examples 2 to 37 and Comparative Examples 1 to 8 was a non-thermoplastic polyimide film.

### Example 2

164.1 g of DIM 2.5 g of TPE-R and 6.7 g of PDA were put in a glass flask having a volume of 500 mL, and 12.4 g of BPDA and 8.0 g of ODPA were put in the flask while the flask contents were stirred. Subsequently, the contents of the flask were stirred for 30 minutes. Subsequently, while the flask contents were stirred, a PMDA solution prepared in advance (solvent: DIM dissolved amount of PMDA: 0.5 g, concentration of PMDA: 7.8 wt %) was continuously added to the flask for a predetermined time at an addition rate which did not cause the viscosity of the flask contents to rapidly increase. At the time when the viscosity of the flask contents at a temperature of 23° C. reached 1500 poise, the addition of the PMDA solution was stopped, and the flask contents were stirred for 1 hour to obtain a polyamide acid solution P2. The obtained polyamide acid solution P2 had a solid content concentration of 15 wt %. The obtained polyamide acid solution P2 had a viscosity of 1500 to 2000 poise at a temperature of 23° C.

Subsequently, 27.5 g of an imidization accelerator including a mixture of AA, IQ and DMF (weight ratio: AA/IQ/DMF=42/21/37) was added to 55 g of the polyamide acid solution P2 (polyamide acid solution P2 obtained by the above-described preparation method) to prepare a dope solution. Subsequently, the dope solution was defoamed while being stirred in an atmosphere at a temperature of 0° C. or lower, and the dope solution was applied onto an aluminum foil with Comma Coater to form a coating film. Subsequently, the coating film was heated at a heating temperature of 110° C. for 180 seconds to obtain a self-supporting gel film. The obtained gel film was peeled off from the aluminum foil, fixed to a metallic fixation frame, put in a hot air circulation oven preheated to a temperature of 300° C., and heated at a heating temperature of 300° C. for 56 seconds. Subsequently, the heated film was put in an IR oven preheated to a temperature of 380° C., and heated at a heating temperature of 380° C. for 49 seconds to imidize the polyamide acid in the gel film, and the film was then separated from the metallic fixation frame to obtain a polyimide film (thickness: 17 μm) of Example 2.

### Example 3

164.1 g of DMF, 2.5 g of TPE-R and 6.7 g of PDA were put in a glass flask having a volume of 500 mL, and 12.5 g of BPDA, 7.4 g of ODPA and 0.5 g of PMDA were put in the flask while the flask contents were stirred. Subsequently, the contents of the flask were stirred for 30 minutes. Subsequently, while the flask contents were stirred, a PMDA solution prepared in advance (solvent: DMF, dissolved amount of PMDA: 0.5 g, concentration of PMDA: 7.8 wt %) was continuously added to the flask for a predetermined time at an addition rate which did not cause the viscosity of the flask contents to rapidly increase. At the time when the viscosity of the flask contents at a temperature of 23° C. reached 1500 poise, the addition of the PMDA solution was stopped, and the flask contents were stirred for 1 hour to obtain a polyamide acid solution P3. The obtained polyamide acid solution P3 had a solid content concentration of 15 wt %. The obtained polyamide acid solution P3 had a viscosity of 1500 to 2000 poise at a temperature of 23° C.

Subsequently, 27.5 g of an imidization accelerator including a mixture of AA, IQ and DMF (weight ratio: AA/IQ/DMF=42/21/37) was added to 55 g of the polyamide acid solution P3 (polyamide acid solution P3 obtained by the above-described preparation method) to prepare a dope solution. Subsequently, the dope solution was defoamed while being stirred in an atmosphere at a temperature of 0° C. or lower, and the dope solution was applied onto an aluminum foil with Comma Coater to form a coating film. Subsequently, the coating film was heated at a heating temperature of 110° C. for 180 seconds to obtain a self-supporting gel film. The obtained gel film was peeled off from the aluminum foil, fixed to a metallic fixation frame, put in a hot air circulation oven preheated to a temperature of 300° C., and heated at a heating temperature of 300° C. for 56 seconds. Subsequently, the heated film was put in an IR oven preheated to a temperature of 380° C., and heated at a heating temperature of 380° C. for 49 seconds to imidize the polyamide acid in the gel film, and the film was then separated from the metallic fixation frame to obtain a polyimide film (thickness: 17 μm) of Example 3.

### Example 4

164.1 g of DMF, 2.5 g of TPE-R and 6.7 g of PDA were put in a glass flask having a volume of 500 mL, and 12.4 g of BPDA, 7.4 g of ODPA and 0.7 g of BTDA were put in the flask while the flask contents were stirred. Subsequently, the contents of the flask were stirred for 30 minutes. Subsequently, while the flask contents were stirred, a PMDA solution prepared in advance (solvent: DMF, dissolved amount of PMDA: 0.5 g, concentration of PMDA: 7.8 wt %) was continuously added to the flask for a predetermined time at an addition rate which did not cause the viscosity of the flask contents to rapidly increase. At the time when the viscosity of the flask contents at a temperature of 23° C. reached 1500 poise, the addition of the PMDA solution was stopped, and the flask contents were stirred for 1 hour to obtain a polyamide acid solution P4. The obtained polyamide acid solution P4 had a solid content concentration of 15 wt %. The obtained polyamide acid solution P4 had a viscosity of 1500 to 2000 poise at a temperature of 23° C.

Subsequently, 27.5 g of an imidization accelerator including a mixture of AA, IQ and DMF (weight ratio: AA/IQ/DMF=42/21/37) was added to 55 g of the polyamide acid solution P4 (polyamide acid solution P4 obtained by the above-described preparation method) to prepare a dope solution. Subsequently, the dope solution was defoamed while being stirred in an atmosphere at a temperature of 0° C. or lower, and the dope solution was applied onto an aluminum foil with Comma Coater to form a coating film. Subsequently, the coating film was heated at a heating temperature of 110° C. for 180 seconds to obtain a self-supporting gel film. The obtained gel film was peeled off from the aluminum foil, fixed to a metallic fixation frame, put in a hot air circulation oven preheated to a temperature of 300° C., and heated at a heating temperature of 300° C. for 56 seconds. Subsequently, the heated film was put in an IR oven preheated to a temperature of 380° C., and heated at a heating temperature of 380° C. for 49 seconds to imidize the polyamide acid in the gel film, and the film was then separated from the metallic fixation frame to obtain a polyimide film (thickness: 17 μm) of Example 4.

### Example 5

### First Sequence Polymerization Step

164.0 g of DMF and 6.9 g of PDA were put in a glass flask having a volume of 500 mL, and 12.5 g of BPDA and 5.5 g of ODPA were put in the flask while the flask contents were stirred. Subsequently, the contents of the flask were stirred for 30 minutes.

### Second Sequence Polymerization Step

Subsequently, 2.1 g of TPER was slowly added to the flask while the flask contents were stirred. TPE-R was visually confirmed to have been dissolved, and 2.6 g of ODPA was then added to the flask while the flask contents were stirred. The flask contents were stirred for 30 minutes. Subsequently, a PMDA solution prepared in advance (solvent: DMF, dissolved amount of PMDA: 0.5 g, concentration of PMDA: 7.7 wt %) was continuously added to the flask for a predetermined time at an addition rate which did not cause the viscosity of the flask contents to rapidly increase. At the time when the viscosity of the flask contents at a temperature of 23° C. reached 1500 poise, the addition of the PMDA solution was stopped, and the flask contents were stirred for 1 hour to obtain a polyamide acid solution P5. The obtained polyamide acid solution P5 had a solid content concentration of 15 wt %. The obtained polyamide acid solution P5 had a viscosity of 1500 to 2000 poise at a temperature of 23° C.

### Film Formation Step

Subsequently, 27.5 g of an imidization accelerator including a mixture of AA, IQ and DMF (weight ratio: AA/IQ/DMF=42/21/37) was added to 55 g of the polyamide acid solution P5 (polyamide acid solution P5 obtained by the above-described preparation method) to prepare a dope solution. Subsequently, the dope solution was defoamed while being stirred in an atmosphere at a temperature of 0° C. or lower, and the dope solution was applied onto an aluminum foil with Comma Coater to form a coating film. Subsequently, the coating film was heated at a heating temperature of 110° C. for 180 seconds to obtain a self-supporting gel film. The obtained gel film was peeled off from the aluminum foil, fixed to a metallic fixation frame, put in a hot air circulation oven preheated to a temperature of 350° C., heated at a heating temperature of 350° C. for 19 seconds, subsequently heated at a heating temperature of 380° C. for 16 seconds, and then at a temperature of 400° C. for 49 seconds to imidize the polyamide acid in the gel film, and then separated from the metallic fixation frame to obtain a polyimide film of Example 5 (thickness: 17 μm).

### Examples 6 and 8 to 37 and Comparative Examples 1 to 3, 5 and 6

Polyimide films of Examples 6 and 8 to 37 and Comparative Examples 1 to 3, 5 and 6 were obtained by the same method as in Example 5 (each having a thickness of 17 μm) except that the type of a monomer used in the first sequence polymerization step, the (addition ratio) thereof, the type of a monomer used in the second sequence polymerization step, the (addition ratio) thereof, the heating conditions in the film formation step, and the weight ratio of the imidization accelerator were as shown in Tables 1 to 10 shown below. The total substance amount of acid dianhydride and diamine in each of Examples 6 and 8 to 37 and Comparative Examples 1 to 3, 5 and 6 was the same as that in Example 5.

### Example 7

### First Sequence Polymerization Step

161.4 g of DMF and 7.4 g of PDA were put in a glass flask having a volume of 500 mL, and 12.7 g of BPDA and 6.7 g of ODPA were put in the flask while the flask contents were stirred. Subsequently, the contents of the flask were stirred for 30 minutes.

### Second Sequence Polymerization Step

Subsequently, 1.0 g of TPER was slowly added to the flask while the flask contents were stirred. TPE-R was visually confirmed to have been dissolved, and 1.5 g of ODPA was then added to the flask while the flask contents were stirred. The flask contents were stirred for 30 minutes. Subsequently, an ODPA solution prepared in advance (solvent: DMF, dissolved amount of ODPA: 0.7 g, concentration of ODPA: 7.5 wt %) was continuously added to the flask for a predetermined time at an addition rate which did not cause the viscosity of the flask contents to rapidly increase. At the time when the viscosity of the flask contents at a temperature of 23° C. reached 1500 poise, the addition of the ODPA solution was stopped, and the flask contents were stirred for 1 hour to obtain a polyamide acid solution P7. The obtained polyamide acid solution P7 had a solid content concentration of 15 wt %. The obtained polyamide acid solution P7 had a viscosity of 1500 to 2000 poise at a temperature of 23° C.

### Film Formation Step

Subsequently, 27.5 g of an imidization accelerator including a mixture of AA, IQ and DMF (weight ratio: AA/IQ/DMF=44/22/34) was added to 55 g of the polyamide acid solution P7 (polyamide acid solution P7 obtained by the above-described preparation method) to prepare a dope solution. Subsequently, the dope solution was defoamed while being stirred in an atmosphere at a temperature of 0° C. or lower, and the dope solution was applied onto an aluminum foil with Comma Coater to form a coating film. Subsequently, the coating film was heated at a heating temperature of 110° C. for 180 seconds to obtain a self-supporting gel film. The obtained gel film was peeled off from the aluminum foil, fixed to a metallic fixation frame, put in a hot air circulation oven preheated to a temperature of 350° C., heated at a heating temperature of 350° C. for 19 seconds, subsequently heated at a heating temperature of 380° C. for 16 seconds, and then at a temperature of 400° C. for 49 seconds to imidize the polyamide acid in the gel film, and then separated from the metallic fixation frame to obtain a polyimide film of Example 7 (thickness: 17 μm).

### Comparative Examples 4, 7 and 8

Polyimide films of Comparative Examples 4, 7 and 8 were obtained by the same method as in Example 7 (each having a thickness of 17 μm) except that the type of a monomer used in the first sequence polymerization step, the (addition ratio) thereof, the type of a monomer used in the second sequence polymerization step, the (addition ratio) thereof, the heating conditions in the film formation step, and the weight ratio of the imidization accelerator were as shown in Tables 5 and 10 shown below. The total substance amount of acid dianhydride and diamine in each of Comparative Examples 4, 7 and 8 was the same as that in Example 7.

### Results

For Examples 1 to 37 and Comparative Examples 1 to 8, the type of a monomer used in the first sequence polymerization step, the (addition ratio) thereof, the type of a monomer used in the second sequence polymerization step, the (addition ratio) thereof and the rigidity/bend ratio are shown in Tables 1 to 5. For Examples 1 to 37 and Comparative Examples 1 to 8, the weight ratio of the imidization accelerator, the heating conditions in the film formation step, the relative dielectric constant, the dielectric loss tangent, the lamellar period and CTE are shown in Tables 6 to 10.

In Tables 1 to 5, “1st” and “2nd” mean a “1st sequence polymerization step” and a “2nd sequence polymerization step”, respectively. For Examples 1 to 4, random polymerization was performed, and therefore the type of a monomer used and the ratio (addition ratio) thereof are described in the column of “1st”.

In Tables 1 to 5, the numerical value in the column of “Diamine” is the content ratio (unit: mol %) of each diamine to the total amount of diamine used (for sequence polymerization, the sum of the total amount of diamine used in the first sequence polymerization step and the total amount of diamine used in the second sequence polymerization step). In Tables 1 to 5, the numerical value in the column of “Acid dianhydride” is the content ratio (unit: mol %) of each acid dianhydride to the total amount of acid dianhydride used (for sequence polymerization, the sum of the total amount of acid dianhydride used in the first sequence polymerization step and the total amount of acid dianhydride used in the second sequence polymerization step). In the columns of “diamine” and “acid dianhydride” in Tables 1 to 5, “-” means that a relevant component (PDA, TPE-R, m-TB, ODA, TPE-Q, BAPP, BPDA, PMDA, TMHQ, BTDA, ODPA or BISDA) was not used. In each of Examples 1 to 37 and Comparative Examples 1 to 8, the molar fraction of each residue in the polyimide contained in the obtained polyimide film was consistent with the molar fraction of each monomer (diamine and tetracarboxylic dianhydride) used. In each of Examples 1 to 37 and Comparative Examples 1 to 8, the substance amount ratio obtained by dividing the total substance amount of tetracarboxylic dianhydride residues forming the polyimide contained in the obtained polyimide film by the total substance amount of diamine residues forming the polyimide was 0.99 or more and 1.01 or less.

In Tables 6 to 10, “-” means that measurement was not performed.

TABLE 1

| | | Diamine [mol %] | | | | | | Acid dianhydride [mol %] | | | | | | Rigidity/bend |
|---|---|---|---|---|---|---|---|---|---|---|---|---|---|---|
| | | PDA | TPE-R | m-TB | ODA | TPE-Q | BAPP | BPDA | PMDA | TMHQ | BTDA | ODPA | BISDA | ratio |
| Example 1 | 1st | 85 | 15 | — | — | — | — | 60 | 3 | — | — | 37 | — | 2.79 |
| | 2nd | — | — | — | — | — | — | — | — | — | — | — | — | |
| Example 2 | 1st | 88 | 12 | — | — | — | — | 60 | 3 | — | — | 37 | — | 3.02 |
| | 2nd | — | — | — | — | — | — | — | — | — | — | — | — | |
| Example 3 | 1st | 88 | 12 | — | — | — | — | 60 | 6 | — | — | 34 | — | 3.22 |
| | 2nd | — | — | — | — | — | — | — | — | — | — | — | — | |
| Example 4 | 1st | 88 | 12 | — | — | — | — | 60 | 3 | — | — | 34 | — | 3.22 |
| | 2nd | — | — | — | — | — | — | — | — | — | — | — | — | |
| Example 5 | 1st | 90 | — | — | — | — | — | 60 | — | — | — | 25 | — | 3.19 |
| | 2nd | — | 10 | — | — | — | — | — | 3 | — | — | 12 | — | |
| Example 6 | 1st | 90 | — | — | — | — | — | 48 | — | — | — | 37 | — | 3.19 |
| | 2nd | — | 10 | — | — | — | — | 12 | 3 | — | — | — | — | |
| Example 7 | 1st | 95 | — | — | — | — | — | 60 | — | — | — | 30 | — | 3.44 |
| | 2nd | — | 5 | — | — | — | — | — | — | — | — | 10 | — | |
| Example 8 | 1st | 63 | — | — | — | — | — | 42 | — | — | — | 18 | — | 2.03 |
| | 2nd | 27 | 10 | — | — | — | — | — | 3 | — | — | 37 | — | |
| Example 9 | 1st | 63 | — | — | — | — | — | 42 | — | — | — | 18 | — | 1.81 |
| | 2nd | 22 | 15 | — | — | — | — | — | 3 | — | — | 37 | — | |

TABLE 2

| | | Diamine [mol %] | | | | | | Acid dianhydride [mol %] | | | | | | Rigidity/bend |
|---|---|---|---|---|---|---|---|---|---|---|---|---|---|---|
| | | PDA | TPE-R | m-TB | ODA | TPE-Q | BAPP | BPDA | PMDA | TMHQ | BTDA | ODPA | BISDA | ratio |
| Example 10 | 1st | 63 | — | — | — | — | — | 39 | 3 | — | — | 18 | — | 1.98 |
| | 2nd | 27 | 10 | — | — | — | — | — | 3 | — | — | 37 | — | |
| Example 11 | 1st | 63 | — | — | — | — | — | 37 | 5 | — | — | 18 | — | 1.95 |
| | 2nd | 27 | 10 | — | — | — | — | — | 3 | — | — | 37 | — | |
| Example 12 | 1st | 63 | — | — | — | — | — | 35 | 7 | — | — | 18 | — | 1.92 |
| | 2nd | 27 | 10 | — | — | — | — | — | 3 | — | — | 37 | — | |
| Example 13 | 1st | 63 | — | — | — | — | — | 37 | 5 | — | — | 18 | — | 1.74 |
| | 2nd | 22 | 15 | — | — | — | — | — | 3 | — | — | 37 | — | |
| Example 14 | 1st | 63 | — | — | — | — | — | 42 | — | — | — | 18 | — | 1.94 |
| | 2nd | 25 | 12 | — | — | — | — | — | 3 | — | — | 37 | — | |
| Example 15 | 1st | 63 | — | — | — | — | — | 37 | 5 | — | — | 18 | — | 1.87 |
| | 2nd | 25 | 12 | — | — | — | — | — | 3 | — | — | 37 | — | |
| Example 16 | 1st | 63 | — | — | — | — | — | 37 | — | 5 | — | 18 | — | 1.95 |
| | 2nd | 27 | 10 | — | — | — | — | — | 3 | — | — | 37 | — | |
| Example 17 | 1st | 63 | — | — | — | — | — | 37 | — | 5 | — | 18 | — | 1.87 |
| | 2nd | 25 | 12 | — | — | — | — | — | 3 | — | — | 37 | — | |
| Example 18 | 1st | 63 | — | — | — | — | — | 37 | — | 5 | — | 18 | — | 1.74 |
| | 2nd | 22 | 15 | — | — | — | — | — | 3 | — | — | 37 | — | |

TABLE 3

| | | Diamine [mol %] | | | | | | Acid dianhydride [mol %] | | | | | | Rigidity/bend |
|---|---|---|---|---|---|---|---|---|---|---|---|---|---|---|
| | | PDA | TPE-R | m-TB | ODA | TPE-Q | BAPP | BPDA | PMDA | TMHQ | BTDA | ODPA | BISDA | ratio |
| Example 19 | 1st | 63 | — | — | — | — | — | 35 | — | 7 | — | 18 | — | 1.92 |
| | 2nd | 27 | 10 | — | — | — | — | — | 3 | — | — | 37 | — | |
| Example 20 | 1st | 63 | — | — | — | — | — | 37 | 5 | — | — | 18 | — | 1.98 |
| | 2nd | 25 | 12 | — | — | — | — | — | 7 | — | — | 33 | — | |
| Example 21 | 1st | 63 | — | — | — | — | — | 37 | 5 | — | — | 18 | — | 2.08 |
| | 2nd | 25 | 12 | — | — | — | — | — | 10 | — | — | 30 | — | |
| Example 22 | 1st | 66 | — | — | — | — | — | 44 | — | — | — | 19 | — | 2.03 |
| | 2nd | 22 | 12 | — | — | — | — | — | 3 | — | — | 34 | — | |
| Example 23 | 1st | 60 | — | — | — | — | — | 40 | — | — | — | 17 | — | 1.86 |
| | 2nd | 28 | 12 | — | — | — | — | — | 3 | — | — | 40 | — | |
| Example 24 | 1st | 66 | — | — | — | — | — | 39 | 5 | — | — | 19 | — | 1.95 |
| | 2nd | 22 | 12 | — | — | — | — | — | 3 | — | — | 34 | — | |
| Example 25 | 1st | 60 | — | — | — | — | — | 35 | 5 | — | — | 17 | — | 1.78 |
| | 2nd | 28 | 12 | — | — | — | — | — | 3 | — | — | 40 | — | |
| Example 26 | 1st | 66 | — | — | — | — | — | 39 | — | 5 | — | 19 | — | 1.95 |
| | 2nd | 22 | 12 | — | — | — | — | — | 3 | — | — | 34 | — | |
| Example 27 | 1st | 63 | — | — | — | — | — | 42 | — | — | — | 18 | — | 2.13 |
| | 2nd | 25 | 12 | — | — | — | — | 4 | 3 | — | — | 33 | — | |

TABLE 4

| | | Diamine [mol %] | | | | | | Acid dianhydride [mol %] | | | | | | Rigidity/bend |
|---|---|---|---|---|---|---|---|---|---|---|---|---|---|---|
| | | PDA | TPE-R | m-TB | ODA | TPE-Q | BAPP | BPDA | PMDA | TMHQ | BTDA | ODPA | BISDA | ratio |
| Example 28 | 1st | 63 | — | — | — | — | — | 39 | — | — | — | 21 | — | 1.81 |
| | 2nd | 25 | 12 | — | — | — | — | — | 3 | — | — | 37 | — | |
| Example 29 | 1st | 63 | — | — | — | — | — | 45 | — | — | — | 15 | — | 2.08 |
| | 2nd | 25 | 12 | — | — | — | — | — | 3 | — | — | 37 | — | |
| Example 30 | 1st | 63 | — | — | — | — | — | 48 | — | — | — | 12 | — | 2.23 |
| | 2nd | 25 | 12 | — | — | — | — | — | 3 | — | — | 37 | — | |
| Example 31 | 1st | 63 | — | — | — | — | — | 40 | 5 | — | — | 15 | — | 2.00 |
| | 2nd | 25 | 12 | — | — | — | — | — | 3 | — | — | 37 | — | |
| Example 32 | 1st | 63 | — | — | — | — | — | 43 | 5 | — | — | 12 | — | 2.15 |
| | 2nd | 25 | 12 | — | — | — | — | — | 3 | — | — | 37 | — | |
| Example 33 | 1st | 62 | 4 | — | — | — | — | 39 | 5 | — | — | 19 | — | 1.78 |
| | 2nd | 22 | 12 | — | — | — | — | — | 3 | — | — | 34 | — | |
| Example 34 | 1st | 62 | 4 | — | — | — | — | 39 | 5 | — | — | 19 | — | 1.87 |
| | 2nd | 24 | 10 | — | — | — | — | — | 3 | — | — | 34 | — | |
| Example 35 | 1st | 62 | 4 | — | — | — | — | 39 | 5 | — | — | 19 | — | 1.95 |
| | 2nd | 26 | 8 | — | — | — | — | — | 3 | — | — | 34 | — | |
| Example 36 | 1st | 62 | 4 | — | — | — | — | 42 | 5 | — | — | 16 | — | 1.91 |
| | 2nd | 22 | 12 | — | — | — | — | — | 3 | — | — | 34 | — | |

TABLE 5

| | | Diamine [mol %] | | | | | | Acid dianhydride [mol %] | | | | | | Rigidity/bend |
|---|---|---|---|---|---|---|---|---|---|---|---|---|---|---|
| | | PDA | TPE-R | m-TB | ODA | TPE-Q | BAPP | BPDA | PMDA | TMHQ | BTDA | ODPA | BISDA | ratio |
| Example 37 | 1st | 62 | 4 | — | — | — | — | 36 | 5 | — | — | 22 | — | 1.67 |
| | 2nd | 22 | 12 | — | — | — | — | — | 3 | — | — | 34 | — | |
| Comparative | 1st | — | — | — | 20 | — | 30 | — | 25 | — | 20 | — | — | — |
| Example 1 | 2nd | 50 | — | — | — | — | — | — | 55 | — | — | — | — | |
| Comparative | 1st | 88 | — | — | — | — | — | 53 | 7 | — | — | 25 | — | 3.81 |
| Example 2 | 2nd | — | 12 | — | — | — | — | — | 3 | — | — | — | 12 | |
| Comparative | 1st | 88 | — | — | — | — | — | 53 | 7 | — | — | 25 | — | 5.64 |
| Example 3 | 2nd | — | — | — | — | 12 | — | — | 3 | — | — | — | 12 | |
| Comparative | 1st | 95 | — | — | — | — | — | 60 | — | — | — | 30 | — | 3.88 |
| Example 4 | 2nd | — | — | — | — | — | 5 | — | — | — | — | 10 | — | |
| Comparative | 1st | 90 | — | — | — | — | — | 60 | — | — | — | 25 | — | 4.66 |
| Example 5 | 2nd | — | 10 | — | — | — | — | 13 | 2 | — | — | — | — | |
| Comparative | 1st | 90 | — | — | — | — | — | 60 | — | — | — | 25 | — | 6.48 |
| Example 6 | 2nd | — | — | 10 | — | — | — | 12 | 3 | — | — | — | — | |
| Comparative | 1st | 90 | — | — | — | — | — | 85 | — | — | — | — | — | 7.00 |
| Example 7 | 2nd | — | 10 | — | — | — | — | — | — | — | — | 15 | — | |
| Comparative | 1st | 90 | — | — | — | — | — | 85 | — | — | — | — | — | 7.00 |
| Example 8 | 2nd | — | 10 | — | — | — | — | — | — | — | — | 15 | — | |

TABLE 6

| | Weight ratio of | | Relative | Dielectric | Lamellar | |
|---|---|---|---|---|---|---|
| | imidization accelerator | Heating conditions in film forming | dielectric | loss | period | CTE |
| | AA/IQ/DMF | step | constant | tangent | [nm] | [ppm/K] |
| Example 1 | 42/21/37 | 110° C. × 180 sec, 300° C. × 56 sec, | 3.46 | 0.00265 | 26.2 | 12.4 |
| | | IR oven 380° C. × 49 sec | | | | |
| Example 2 | 42/21/37 | 110° C. × 180 sec, 300° C. × 56 sec, | 3.43 | 0.00267 | 32.2 | 14.0 |
| | | IR oven 380° C. × 49 sec | | | | |
| Example 3 | 42/21/37 | 110° C. × 180 sec, 300° C. × 56 sec, | 3.55 | 0.00262 | 30.6 | 10.7 |
| | | IR oven 380° C. × 49 sec | | | | |
| Example 4 | 42/21/37 | 110° C. × 180 sec, 300° C. × 56 sec, | 3.54 | 0.00266 | 26.7 | 10.8 |
| | | IR oven 380° C. × 49 sec | | | | |
| Example 5 | 42/21/37 | 110° C. × 180 sec, 350° C. × 19 sec, | 3.52 | 0.00284 | 26.9 | 7.5 |
| | | 380° C. × 16 sec, 400° C. × 49 sec | | | | |
| Example 6 | 29/9/62 | 110° C. × 133 sec, 250° C. × 15 sec, | 3.47 | 0.00288 | 23.7 | 7.2 |
| | | 400° C. × 79 sec | | | | |
| Example 7 | 44/22/34 | 110° C. × 180 sec, 350° C. × 19 sec, | 3.48 | 0.00282 | 28.2 | 7.9 |
| | | 380° C. × 16 sec, 400° C. × 49 sec | | | | |
| Example 8 | 14/7/79 | 110° C. × 160 sec, 300° C. × 56 sec, | 3.49 | 0.00266 | 30.3 | 9.0 |
| | | IR oven 380° C. × 49 sec | | | | |
| Example 9 | 14/7/79 | 110° C. × 160 sec, 300° C. × 56 sec, | 3.51 | 0.00272 | 31.0 | 11.0 |
| | | IR oven 380° C. × 49 sec | | | | |

TABLE 7

| | Weight ratio of | | Relative | Dielectric | Lamellar | |
|---|---|---|---|---|---|---|
| | imidization accelerator | Heating conditions in film forming | dielectric | loss | period | CTE |
| | AA/IQ/DMF | step | constant | tangent | [nm] | [ppm/K] |
| Example 10 | 14/7/79 | 110° C. × 160 sec, 300° C. × 56 sec, | 3.46 | 0.00256 | 34.9 | 10.8 |
| | | IR oven 380° C. × 49 sec | | | | |
| Example 11 | 14/7/79 | 110° C. × 160 sec, 300° C. × 56 sec, | 3.53 | 0.00258 | 33.2 | 11.4 |
| | | IR oven 380° C. × 49 sec | | | | |
| Example 12 | 14/7/79 | 110° C. × 160 sec, 300° C. × 56 sec, | 3.48 | 0.00261 | 36.0 | — |
| | | IR oven 380° C. × 49 sec | | | | |
| Example 13 | 14/7/79 | 110° C. × 160 sec, 300° C. × 56 sec, | 3.44 | 0.00255 | 35.9 | 14.8 |
| | | IR oven 380° C. × 49 sec | | | | |
| Example 14 | 14/7/79 | 110° C. × 160 sec, 300° C. × 56 sec, | 3.48 | 0.00269 | 30.1 | 10.5 |
| | | IR oven 380° C. × 49 sec | | | | |
| Example 15 | 14/7/79 | 110° C. × 160 sec, 300° C. × 56 sec, | 3.49 | 0.00252 | 34.6 | 11.0 |
| | | IR oven 380° C. × 49 sec | | | | |
| Example 16 | 14/7/79 | 110° C. × 160 sec, 300° C. × 56 sec, | 3.39 | 0.00258 | 36.9 | — |
| | | IR oven 380° C. × 49 sec | | | | |
| Example 17 | 14/7/79 | 110° C. × 160 sec, 300° C. × 56 sec, | 3.47 | 0.00253 | 37.2 | 8.7 |
| | | IR oven 380° C. × 49 sec | | | | |
| Example 18 | 14/7/79 | 110° C. × 160 sec, 300° C. × 56 sec, | 3.43 | 0.00260 | 40.3 | — |
| | | IR oven 380° C. × 49 sec | | | | |

TABLE 8

| | Weight ratio of | | Relative | Dielectric | Lamellar | |
|---|---|---|---|---|---|---|
| | imidization accelerator | Heating conditions in film forming | dielectric | loss | period | CTE |
| | AA/IQ/DMF | step | constant | tangent | [nm] | [ppm/K] |
| Example 19 | 14/7/79 | 110° C. × 160 sec, 300° C. × 56 sec, | 3.43 | 0.00250 | 36.9 | — |
| | | IR oven 380° C. × 49 sec | | | | |
| Example 20 | 14/7/79 | 110° C. × 160 sec, 300° C. × 56 sec, | 3.46 | 0.00271 | 38.4 | 13.6 |
| | | IR oven 380° C. × 49 sec | | | | |
| Example 21 | 14/7/79 | 110° C. × 160 sec, 300° C. × 56 sec, | 3.47 | 0.00291 | 37.1 | — |
| | | IR oven 380° C. × 49 sec | | | | |
| Example 22 | 14/7/79 | 110° C. × 160 sec, 300° C. × 56 sec, | 3.45 | 0.00265 | 30.9 | — |
| | | IR oven 380° C. × 49 sec | | | | |
| Example 23 | 14/7/79 | 110° C. × 160 sec, 300° C. × 56 sec, | 3.48 | 0.00261 | 29.9 | — |
| | | IR oven 380° C. × 49 sec | | | | |
| Example 24 | 14/7/79 | 110° C. × 160 sec, 300° C. × 56 sec, | 3.47 | 0.00247 | 37.1 | 10.4 |
| | | IR oven 380° C. × 49 sec | | | | |
| Example 25 | 14/7/79 | 110° C. × 160 sec, 300° C. × 56 sec, | 3.43 | 0.00261 | 33.5 | — |
| | | IR oven 380° C. × 49 sec | | | | |
| Example 26 | 14/7/79 | 110° C. × 160 sec, 300° C. × 56 sec, | 3.46 | 0.00247 | 33.3 | — |
| | | IR oven 380° C. × 49 sec | | | | |
| Example 27 | 14/7/79 | 110° C. × 160 sec, 300° C. × 56 sec, | 3.42 | 0.00256 | 30.6 | — |
| | | IR oven 380° C. × 49 sec | | | | |

TABLE 9

| | Weight ratio of | | Relative | Dielectric | Lamellar | |
|---|---|---|---|---|---|---|
| | imidization accelerator | Heating conditions in film forming | dielectric | loss | period | CTE |
| | AA/IQ/DMF | step | constant | tangent | [nm] | [ppm/K] |
| Example 28 | 14/7/79 | 110° C. × 160 sec, 300° C. × 56 sec, | 3.45 | 0.00265 | 25.3 | — |
| | | IR oven 380° C. × 49 sec | | | | |
| Example 29 | 14/7/79 | 110° C. × 160 sec, 300° C. × 56 sec, | 3.50 | 0.00272 | 24.1 | — |
| | | IR oven 380° C. × 49 sec | | | | |
| Example 30 | 14/7/79 | 110° C. × 160 sec, 300° C. × 56 sec, | 3.47 | 0.00245 | 27.1 | — |
| | | IR oven 380° C. × 49 sec | | | | |
| Example 31 | 14/7/79 | 110° C. × 160 sec, 300° C. × 56 sec, | 3.43 | 0.00260 | 37.1 | — |
| | | IR oven 380° C. × 49 sec | | | | |
| Example 32 | 14/7/79 | 110° C. × 160 sec, 300° C. × 56 sec, | 3.45 | 0.00264 | 38.7 | — |
| | | IR oven 380° C. × 49 sec | | | | |
| Example 33 | 14/7/79 | 110° C. × 160 sec, 300° C. × 56 sec, | 3.56 | 0.00206 | 50.2 | 15.6 |
| | | IR oven 380° C. × 49 sec | | | | |
| Example 34 | 14/7/79 | 110° C. × 160 sec, 300° C. × 56 sec, | 3.36 | 0.00216 | 46.3 | 11.4 |
| | | IR oven 380° C. × 49 sec | | | | |
| Example 35 | 14/7/79 | 110° C. × 160 sec, 300° C. × 56 sec, | 3.35 | 0.00220 | 42.8 | 13.1 |
| | | IR oven 380° C. × 49 sec | | | | |
| Example 36 | 14/7/79 | 110° C. × 160 sec, 300° C. × 56 sec, | 3.39 | 0.00228 | 40.6 | — |
| | | IR oven 380° C. × 49 sec | | | | |

TABLE 10

| | Weight ratio of | | Relative | Dielectric | Lamellar | |
|---|---|---|---|---|---|---|
| | imidization accelerator | Heating conditions in film forming | dielectric | loss | period | CTE |
| | AA/IQ/DMF | step | constant | tangent | [nm] | [ppm/K] |
| Example 37 | 14/7/79 | 110° C. × 160 sec, 300° C. × 56 sec, | 3.43 | 0.00233 | 32.7 | 17.4 |
| | | IR oven 380° C. × 49 sec | | | | |
| Comparative | 37/11/52 | 110° C. × 133 sec, 250° C. × 15 sec, | 3.30 | 0.01100 | 10.2 | 11.0 |
| Example 1 | | 400° C. × 79 sec | | | | |
| Comparative | 30/21/49 | 110° C. × 180 sec, 300° C. × 56 sec, | 3.43 | 0.00303 | — | — |
| Example 2 | | IR oven 380° C. × 49 sec | | | | |
| Comparative | 32/22/46 | 110° C. × 180 sec, 300° C. × 56 sec, | 3.45 | 0.00331 | — | — |
| Example 3 | | IR oven 380° C. × 49 sec | | | | |
| Comparative | 44/22/34 | 110° C. × 180 sec, 350° C. × 19 sec, | 3.57 | 0.00386 | — | 12.3 |
| Example 4 | | 380° C. × 16 sec, 350° C. × 49 sec | | | | |
| Comparative | 29/9/62 | 110° C. × 133 sec, 250° C. × 15 sec, | 3.51 | 0.00301 | — | 7.0 |
| Example 5 | | 400° C. × 79 sec | | | | |
| Comparative | 29/9/62 | 110° C. × 133 sec, 250° C. × 15 sec, | 3.31 | 0.00328 | — | 6.7 |
| Example 6 | | 400° C. × 79 sec | | | | |
| Comparative | 29/4/67 | 110° C. × 133 sec, 250° C. × 15 sec, | 3.02 | 0.00473 | — | 7.6 |
| Example 7 | | 350° C. × 79 sec | | | | |
| Comparative | 29/4/67 | 110° C. × 133 sec, 250° C. × 15 sec, | 3.32 | 0.00406 | — | 7.1 |
| Example 8 | | 400° C. × 79 sec | | | | |

The non-thermoplastic polyimide contained in the polyimide film of each of Examples 1 to 37 had a BPDA residue, an ODPA residue, a PDA residue and a TPE-R residue. In Examples 1 to 37, the total content ratio of the BPDA residue and the ODPA residue to all tetracarboxylic dianhydride residues forming the non-thermoplastic polyimide was 80 mol % or more. In Examples 1 to 37, the total content ratio of the PDA residue and the TPE-R residue to all diamine residues forming the non-thermoplastic polyimide was 80 mol % or more. In Examples 1 to 37, the rigidity/bend ratio was 3.50 or less. In Examples 1 to 37, the lamellar period was 15 nm or more.

In Examples 1 to 37, the dielectric loss tangent was less than 0.0030. Thus, the polyimide films of Examples 1 to 37 had a reduced dielectric loss tangent.

The non-thermoplastic polyimide contained in each of the polyimide films of Comparative Examples 1, 3, 4 and 6 had no TPE-R residue. The non-thermoplastic polyimide contained in the polyimide film of Comparative Example 1 did not have a BPDA residue and an ODPA residue. In Comparative Examples 2 and 3, the total content ratio of the BPDA residue and the ODPA residue to all tetracarboxylic dianhydride residues forming the non-thermoplastic polyimide was less than 80 mol %. In Comparative Examples 2 to 8, the rigidity/bending ratio was more than 3.50 In Comparative Example 1, the lamellar period was less than 15 nm.

In Comparative Examples 1 to 8, the dielectric loss tangent was 0.0030 or more. Thus, the polyimide films of Comparative Examples 1 to 8 did not have a reduced dielectric loss tangent

The above results showed that according to one or more embodiments of the present invention, it was possible to provide a non-thermoplastic polyimide film which has a reduced dielectric loss tangent.

### DESCRIPTION OF REFERENCE SIGNS

10 multi-layered polyimide film
11 Specific non-thermoplastic polyimide film (non-thermoplastic polyimide film)
12 adhesive layer
13 metal layer
20 metal-clad laminate

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A non-thermoplastic polyimide film comprising non-thermoplastic polyimide,
wherein the non-thermoplastic polyimide has a 3,3′,4,4′-biphenyltetracarboxylic dianhydride residue and a 4,4′-oxydiphthalic anhydride residue as tetracarboxylic dianhydride residues, and a p-phenylenediamine residue and a 1,3-bis(4-aminophenoxy)benzene residue as diamine residues, and
where a content ratio of the 3,3′,4,4′-biphenyltetracarboxylic dianhydride residue to all tetracarboxylic dianhydride residues forming the non-thermoplastic polyimide is A₁ mol %, a content ratio of the 4,4′-oxydiphthalic anhydride residue to all tetracarboxylic dianhydride residues forming the non-thermoplastic polyimide is A₂ mol %, a content ratio of the p-phenylenediamine residue to all diamine residues forming the non-thermoplastic polyimide is B₁ mol %, and a content ratio of the 1,3-bis(4-aminophenoxy)benzene residue to all diamine residues forming the non-thermoplastic polyimide is B₂ mol %, relationships of A₁+A₂≥80, B₁+B₂≥80 and (A₁+B₁)/(A₂+B₂)≤3.50 are satisfied.

2. The non-thermoplastic polyimide film according to claim 1, wherein A₁, A₂, B₁ and B₂ satisfy the relationship of 1.60≤(A₁+B₁)/(A₂+B₂)≤3.50.

3. The non-thermoplastic polyimide film according to claim 1, wherein the non-thermoplastic polyimide further has a pyromellitic dianhydride residue as the tetracarboxylic dianhydride residue.

4. The non-thermoplastic polyimide film according to claim 3, wherein a content ratio of the pyromellitic dianhydride residue to all tetracarboxylic dianhydride residues forming the non-thermoplastic polyimide is 3 mol % or more and 12 mol % or less.

5. The non-thermoplastic polyimide film according to claim 1, wherein a substance amount ratio obtained by dividing a total substance amount of tetracarboxylic dianhydride residues forming the non-thermoplastic polyimide by a total substance amount of diamine residues forming the non-thermoplastic polyimide is 0.95 or more and 1.05 or less.

6. The non-thermoplastic polyimide film according to claim 1, comprising:
a crystal portion having a lamellar structure; and
an amorphous portion sandwiched between the crystal portions,
wherein a lamellar period obtained by an X-ray scattering method is 15 nm or more.

7. A non-thermoplastic polyimide film comprising:
non-thermoplastic polyimide;
a crystal portion having a lamellar structure; and
an amorphous portion sandwiched between the crystal portions,
wherein a lamellar period obtained by an X-ray scattering method is 15 nm or more.

8. A multi-layered polyimide film comprising:
the non-thermoplastic polyimide film according to claim 1; and
an adhesive layer that is disposed on at least one surface of the non-thermoplastic polyimide film and contains thermoplastic polyimide.

9. The multi-layered polyimide film according to claim 8, wherein the adhesive layer is disposed on each of both surfaces of the non-thermoplastic polyimide film.

10. A metal-clad laminate comprising:
the non-thermoplastic polyimide film according to claim 1; and
a metal layer disposed on at least one surface of the non-thermoplastic polyimide film.

11. A metal-clad laminate comprising:
the multi-layered polyimide film according to claims 8; and
a metal layer disposed on a main surface of at least one of the adhesive layers of the multi-layered polyimide film.
